(19) United States
(12) Patent Application Publication
(10) Pub. No.: US 2026/0352953 A1
(43) Pub. Date: Nov. 5, 2026

(54) Camera Actuator With Single Stage Optical Image Stabilization (OIS) Assembly

(71) Applicant: Apple Inc., Cupertino, CA (US)

(72) Inventors: Justin C Brunnett, San Ramon, CA (US); Alfred N Mireault, San Francisco, CA (US); Kevin Garrison, San Jose, CA (US); Nicholas D Smyth, San Jose, CA (US); Scott W Miller, Los Gatos, CA (US)

(73) Assignee: Apple Inc., Cupertino, CA (US)

(21) Appl. No.: 19/654,268

(22) Filed: Apr. 21, 2026

Related U.S. Application Data
(60) Provisional application No. 63/799,264, filed on May 2, 2025.

(51) Int. Cl. H04N 23/68; G03B 13/36; H04N 23/54

(52) U.S. Cl. CPC H04N 23/687; G03B 13/36; H04N 23/54

(57) ABSTRACT

A camera includes an image sensor, an optical assembly having one or more lenses, and actuator assembly configured to move one of the image sensor or the optical assembly. The actuator assembly includes an optical image stabilization (OIS) carrier. The OIS carrier is configured to move one of the image sensor or the optical assembly along two orthogonal axes for OIS. The actuator assembly also includes a plurality of surfaces on the OIS carrier. A surface portion of the plurality of surfaces is configured to make physical contact with another surface of another component to allow sliding or rolling movement between the surface portion of the plurality of surfaces and the other surface of the other component for allowing movement of the OIS carrier along the two orthogonal axes. The actuator assembly further includes an OIS actuator configured to move the OIS carrier along the two orthogonal axes.

### PRIORITY CLAIM

This application claims benefit of priority to U.S. Provisional Application Serial No. 63/799,264, entitled “CAMERA ACTUATOR WITH SINGLE STAGE OPTICAL IMAGE STABILIZATION (OIS) ASSEMBLY,” filed May 2, 2025, and which is hereby incorporated herein by reference in its entirety.

### BACKGROUND

### Technical Field

This disclosure relates generally to a camera module with a voice coil motor (VCM) optical image stabilization (OIS) actuator assembly for lens-shift using a single stage OIS carrier.

### Description of the Related Art

The advent of small, mobile multipurpose devices such as smartphones and tablet or pad devices has resulted in a need for high-resolution, small form factor cameras for integration in the devices. Some cameras may incorporate an autofocus (AF) mechanism whereby the object focal distance can be adjusted to focus an object plane in front of the camera at an image plane to be captured by the image sensor. Further, some cameras may incorporate optical image stabilization (OIS) mechanisms that may sense and react to external excitation/disturbance by adjusting location of the optical lens on the X and/or Y axis in an attempt to compensate for unwanted motion of the lens.

### BRIEF DESCRIPTION OF THE DRAWINGS

FIG. 1 illustrates components of an example camera having an actuator module or assembly that may, for example, be used to provide autofocus (AF) and optical image stabilization (OIS) through lens movement in small form factor cameras, according to at least some embodiments. FIG. 1 shows an overhead view of the exterior of the camera.

FIG. 2 illustrates components of an example camera having an actuator module or assembly that may, for example, be used to provide AF and OIS through lens movement in small form factor cameras, according to at least some embodiments. FIG. 2 shows a cross-sectional view of the camera.

FIG. 3 illustrates components of an example actuator module or assembly that may, for example, be used to provide AF and OIS through lens movement in small form factor cameras, according to at least some embodiments. FIG. 3 shows an exploded perspective view of the actuator module or assembly.

FIG. 4 illustrates components of an example actuator module or assembly that may, for example, be used to provide OIS through lens movement in small form factor cameras, according to at least some embodiments. FIG. 4 shows a cross-sectional view of an actuator module or assembly.

FIG. 5 illustrates components of an example actuator module or assembly that may, for example, be used to provide AF and OIS through lens movement in small form factor cameras, according to at least some embodiments. FIG. 5 shows a cross-sectional view of the actuator module or assembly.

FIG. 6 illustrates components of an example actuator module or assembly that may, for example, be used to provide AF and OIS through lens movement in small form factor cameras, according to at least some embodiments. FIG. 6 shows an exploded perspective view of the actuator module or assembly.

FIG. 7 illustrates components of an example rotation restriction mechanism of actuator module or assembly that may, for example, be used to provide AF and OIS through lens movement in small form factor cameras, according to at least some embodiments. FIG. 7 shows an overhead view of the rotation restriction mechanism of actuator module or assembly.

FIG. 8a illustrates components of an example rotation restriction mechanism for an actuator module or assembly that may, for example, be used to provide AF and OIS through lens movement in small form factor cameras, according to at least some embodiments. FIG. 8a shows perspective view of a rotation restriction mechanism.

FIG. 8b illustrates components of an example rotation restriction mechanism for an actuator module or assembly that may, for example, be used to provide AF and OIS through lens movement in small form factor cameras, according to at least some embodiments. FIG. 8b shows perspective view of a rotation restriction mechanism.

FIG. 8c illustrates components of an example rotation restriction mechanism for an actuator module or assembly that may, for example, be used to provide AF and OIS through lens movement in small form factor cameras, according to at least some embodiments. FIG. 8c shows perspective view of a rotation restriction mechanism.

FIG. 9 illustrates components of OIS carrier surfaces that may, for example, be used to provide OIS through lens movement in small form factor cameras, according to at least some embodiments. FIG. 9 shows an overhead view and cross-sectional views of the OIS carrier surfaces.

FIG. 10 illustrates components of other OIS carrier surfaces that may, for example, be used to provide OIS through lens movement in small form factor cameras, according to at least some embodiments. FIG. 10 shows cross-sectional views of the OIS carrier surfaces.

FIG. 11 illustrates components of yet other OIS carrier surfaces that may, for example, be used to provide OIS through lens movement in small form factor cameras, according to at least some embodiments. FIG. 11 shows an overhead view and cross-sectional views of the OIS carrier surfaces.

FIG. 12 illustrates components of yet other OIS carrier surfaces that may, for example, be used to provide OIS through lens movement in small form factor cameras, according to at least some embodiments. FIG. 12 shows a cross-sectional views of the OIS carrier surfaces.

FIG. 13 illustrates components of yet other OIS carrier surfaces that may, for example, be used to provide OIS through lens movement in small form factor cameras, according to at least some embodiments. FIG. 13 shows a cross-section view of the OIS carrier surfaces.

FIG. 14 illustrates components of yet other OIS carrier surfaces that may, for example, be used to provide OIS through lens movement in small form factor cameras, according to at least some embodiments. FIG. 14 shows a cross-sectional view of the OIS carrier surfaces.

FIG. 15 illustrates components of yet other OIS carrier surfaces that may, for example, be used to provide OIS through lens movement in small form factor cameras, according to at least some embodiments. FIG. 15 shows a cross-sectional view of the OIS carrier surfaces.

FIG. 16 illustrates components of yet other OIS carrier surfaces that may, for example, be used to provide OIS through lens movement in small form factor cameras, according to at least some embodiments. FIG. 16 shows a cross-sectional view of the OIS carrier surfaces.

FIG. 17 illustrates components of yet other OIS carrier surfaces that may, for example, be used to provide OIS through lens movement in small form factor cameras, according to at least some embodiments. FIG. 17 shows a cross-sectional view of the OIS carrier surfaces.

FIG. 18 illustrates a schematic representation of an example device that may include a camera, in accordance with some embodiments.

FIG. 19 illustrates a schematic block diagram of an example computing device, referred to as computer system, that may include or host embodiments of a camera, in accordance with some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units ….” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112, sixth paragraph, for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine a based on B.” While in this case, b is a factor that affects the determination of A, such a phrase does not foreclose the determination of a from also being based on C. In other instances, a may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term "and/or" as used herein refers to and encompasses any and all possible combinations of one or more of the associated listed items. It will be further understood that the terms "includes," "including," "comprises," and/or "comprising," when used in this specification, specify the presence of stated features, integers, steps, operations, elements, and/or components, but do not preclude the presence or addition of one or more other features, integers, steps, operations, elements, components, and/or groups thereof.

As used herein, the term "if" may be construed to mean "when" or "upon" or "in response to determining" or "in response to detecting," depending on the context. Similarly, the phrase "if it is determined" or "if [a stated condition or event] is detected" may be construed to mean "upon determining" or "in response to determining" or "upon detecting [the stated condition or event]" or "in response to detecting [the stated condition or event]," depending on the context.

### DETAILED DESCRIPTION

Various embodiments described herein relate to an actuator module or assembly that may be used in a camera with a moveable optical assembly. In some examples, the camera may include camera equipment outfitted with controls, magnets, and voice coil motors to improve the effectiveness of a miniature actuation mechanism for a compact camera module. More specifically, in some embodiments, compact camera modules include actuators to deliver functions such as autofocus (AF) and optical image stabilization (OIS). One approach to delivering a very compact actuator assembly is to provide OIS actuation for movement and/or shift of the optical assembly via a single carrier.

Compact cameras (e.g., camera modules) may be used across a variety of mobile devices from cell phones to AR/VR devices. Many cameras may implement AF actuators in order to improve focus performance and support lower F-numbers and OIS actuators to compensate for shaking and movement of the camera. In some applications, a camera actuator assembly may include a plurality of carriers, ball bearings, and associated actuators to move an optical assembly in the x, y, and/or z directions. For OIS systems of camera actuator assemblies, a significant challenge may arise from two separate stages for x and y lens shift or motion, typically employing ball-bearing applications. This dual-stage approach, while effective, may introduce complexity with additional parts which may increase the potential for failure modes, elevate costs, and demand more space (for example, z space) within the design. For instance, each stage of the two-stages may necessitate its own set of components, such as bearings and raceways, which may lead to a mechanically intricate system that can be cumbersome in compact applications where space is at a premium. This complexity may not only complicate assembly but may also pose reliability risks over time due to the increased number of moving parts, particularly in scenarios like drop events where components may shift or misalign, resulting in non-linear behavior that affects performance.

To address these problems, a camera actuator system may have a single-stage OIS system capable of combined x-y lens shift or motion. A single-stage OIS system may significantly reduce complexity by minimizing the number of parts, thereby lowering costs, enhancing reliability, and crucially, saving space. In some aspects, the single-stage OIS system may have sliding surfaces or constrained ball-bearing regions (for example, instead of ball-bearing and raceway systems), which can achieve low-friction, repeatable actuation in both x and y directions. To maintain contact and stability with a single-stage OIS system, a magnetic preload may be used to ensure that the sliding surfaces or constrained ball-bearing regions remain biased against each other. Additionally, to minimize or prevent rotational movement of the optics assembly with a single-stage OIS system, a rotation restriction mechanism may be included to provide high torsional stiffness, reducing and/or preventing unwanted rotation while preserving low stiffness in the x-y plane. The single-stage OIS system, as provided herein, may not only be simpler than many other OIS systems including multi-stage OIS systems, but may also maintain performance by ensuring precise, repeatable motion.

As described herein, a camera with an actuator module or assembly is provided having a single carrier and OIS actuators for OIS movement of the optical assembly. The actuator assembly may include a single OIS carrier having an aperture extending therethrough for receiving a lens carrier. The lens carrier having one or more lenses may rest on one or more surfaces of the OIS carrier so that the lens carrier moves with the OIS carrier in the x and y directions for OIS movement. The OIS carrier may be vertically positioned (for example, along an optical axis) between a shield can or housing and a base. The housing may include a spacer with one or more top surfaces for engaging with (for example, make physical contact with) one or more respective upper surfaces of the OIS carrier. In some aspects, the engaging may be for sliding movement between two flat surfaces or rolling movement between a flat surface and a rounded surface. Pre-load magnets positioned within the housing and/or within the spacer that are vertically aligned with OIS magnets attached to the OIS carrier may bias the carrier towards the housing and/or spacer to facilitate maintained engagement between the upper surface(s) of the OIS carrier and respective top surface(s) of the housing and/or spacer for movement (for example, sliding movement) of the OIS carrier in the x and y directions relative to the housing and/or the spacer. Alternatively, the base may include one or more bottom surfaces for engaging (for example, make physical contact with) with one or more respective lower surfaces of the OIS carrier. In some aspects, the engaging may be for sliding movement between two flat surfaces or rolling movement between a flat surface and a rounded surface. Pre-load magnets positioned within the base that are vertically aligned with the OIS magnets attached to the OIS carrier may bias the carrier towards the base to facilitate maintained engagement between the lower surface(s) of the OIS carrier and respective bottom surface(s) of the base for movement (for example, sliding movement) of the OIS carrier in the x and y directions relative to the base.

As mentioned herein, the OIS carrier may include OIS magnets. For example, the OIS carrier may include an OIS magnet positioned within an arm of the OIS carrier and another OIS magnet positioned in an adjacent arm of the OIS carrier. The arm may extend in a direction orthogonal to the adjacent arm. As such one OIS magnet in an arm may be for x direction OIS movement of the OIS carrier and the lens carrier and the other OIS magnet in the adjacent arm may be for y direction OIS movement of the OIS carrier and the lens carrier. The base may be positioned below the OIS carrier in the z direction along the optical axis. The base may include OIS coils with a boarder side facing the OIS carrier for interacting with the OIS magnets. For instance, the base may include an OIS coil vertically aligned with an OIS magnet positioned within the arm of the OIS carrier and another OIS coil vertically aligned with the other OIS magnet positioned within the adjacent arm of the OIS carrier. When an OIS coil receives electric current, the electric current interacts with the magnetic field produced by the vertically aligned OIS magnet causing the OIS carrier and the lens carrier to move for OIS. For example, when one OIS coil receives electric current, the electric current interacts with the magnetic field produced by the vertically aligned OIS magnet within one arm of the OIS carrier causing the OIS carrier and the lens carrier to move, via sliding engagement between upper surfaces of the OIS carrier and top surfaces of the spacer, in the x direction for OIS. As another example, when another OIS coil receives electric current, the electric current interacts with the magnetic field produced by the vertically aligned OIS magnet within an adjacent arm of the OIS carrier causing the OIS carrier and the lens carrier to move, via sliding engagement between upper surfaces of the OIS carrier and top surfaces of the spacer, in the y direction for OIS. In some aspects, the spacer and/or the housing may include side walls for limiting the distance that the OIS carrier can move in the x and y directions. In some aspects, each of the OIS coils positioned on the base may be paired with a position sensor for determining the relative position of the OIS carrier in the x and y directions. For example, an OIS coil interacting with an OIS magnet for causing OIS movement of the OIS carrier in the x direction may be paired with a position sensor to determine a relative position of the OIS carrier and the lens carrier in the x direction. As another example, another OIS coil interacting with another OIS magnet for causing OIS movement of the OIS carrier in the y direction may be paired with another position sensor to determine a relative position of the OIS carrier and the lens carrier in the y direction.

In some aspects and as described herein, the OIS carrier may include a pair of vertical raceways that are paired with a pair of vertical carrier tracks on the lens carrier. The vertical raceways and vertical carrier tracks paired together may each contain one or more ball bearings. Because the lens carrier rests on the OIS carrier, the lens carrier may move vertically along in the z direction (for example, along the optical axis) relative to the OIS carrier for AF using the pairs of vertical raceways and vertical carrier tracks containing the ball bearings as guides. . In some aspects, the lens carrier may be fixedly attached to the OIS carrier, for example, when the camera module does not implement AF lens shift. For AF movement of the lens carrier relative to the OIS carrier, the OIS carrier may include an AF coil. The AF coil may be positioned on an arm of the OIS carrier, for example, opposite an arm of the OIS carrier having one of the OIS magnets. Additionally, or alternatively, the AF coil may be positioned between the AF carrier raceways on an arm or wall of the OIS carrier.

The OIS carrier may also include an AF coil electrical connection for providing electric current to the AF coil from a stationary component of the camera. For example, the AF coil electrical connection(s) may be electrically connected to the AF coil and may wrap along and over an outer perimeter of the OIS carrier for electrical connection with a stationary component of the camera that provides electric current. In some aspect, the AF coil connections may be a pair of AF coil electrical connections with one AF coil electrical connection that is electrically connected to the AF coil and wraps along and over a half of an outer perimeter of the OIS carrier on one side of the OIS carrier another AF coil electrical connection that is also electrically connected to the AF coils and wraps along and over another half of an outer perimeter of the OIS carrier on an opposite side of the OIS carrier so that both AF coil electrical connections arrive at the same stationary component of the camera for a supply current and a return current, respectively. In some aspects, the AF coil electrical connection(s) may flex to permit or allow movement of the OIS carrier while maintaining electrical connections with the AF coil and the stationary component of the camera.

In addition, for AF movement of the lens carrier, the lens carrier may include an AF magnet. The AF magnet may be positioned on a wall or side surface of the lens carrier so that when the lens carrier is positioned with the OIS carrier, the AF magnet may be adjacent to the AF coil positioned with the OIS carrier. For example, the AF magnet may be positioned on a wall or side surface of the lens carrier that is not adjacent or next to an arm of the OIS carrier that contains an OIS magnet and instead contains the AF coil. Additionally, or alternatively, the AF magnet may be positioned on a wall or side surface of the lens carrier and between the AF carrier tracks on the lens carrier so that the AF magnet on the lens carrier is positioned adjacent to the AF coil on the OIS carrier. When the AF coil on the OIS carrier receives electric current from the stationary component of the camera and via the AF coil electrical connection(s), the electric current interacts with the magnetic field produced by the adjacent AF magnet positioned on the lens carrier causing the lens carrier to move for AF. For example, when the AF coil on the OIS carrier receives electric current from the stationary component of the camera and via the AF coil electrical connection(s), the electric current interacts with the magnetic field produced by the adjacent AF magnet positioned on the lens carrier causing the lens carrier to move, via the ball bearing within the paired AF carrier tracks and AF carrier raceways, relative to the OIS carrier in a z direction (for example, along the optical axis) away from the OIS carrier and base. As another example, when the AF coil on the OIS carrier receives electric current from the stationary component of the camera and via the AF coil electrical connection(s), the electric current interacts with the magnetic field produced by the adjacent AF magnet positioned on the lens carrier causing the lens carrier to move, via the ball bearing within the paired AF carrier tracks and AF carrier raceways, relative to the OIS carrier in a z direction (for example, along the optical axis) towards the OIS carrier and the base.

Due to movement of the lens carrier in the x direction and/or the y direction for OIS, uncontrolled rotation of the lens carrier about the optical axis may occur. Uncontrolled rotation of the lens carrier about the optical axis may introduce position errors causing x and y accuracy and/or image quality degradation. In some aspects, a rotation restriction mechanism may be provided to the lens carrier for introducing rotational stiffness of the lens carrier about the optical axis while providing little or no stiffness for OIS and AF movement of the lens carrier. For instance, the rotation restriction mechanism may be fixedly attached to the shield can at one section of the rotation restriction mechanism and fixedly attached to at least one of the lens carrier or the OIS carrier at another section of the rotation restriction mechanism. Alternatively, the rotation restriction mechanism may be fixedly attached to the OIS carrier at one section of the rotation restriction mechanism and fixedly attached the lens carrier at another section of the rotation restriction mechanism. The rotation restriction mechanism may allow for OIS and/or AF movement of the lens carrier while restricting rotational movement of the lens carrier (and the OIS carrier) about the optical axis. In some aspects, the rotation restriction mechanism may include one or more springs (for example one or more flexure arms), one or more magnet and coil pairs, and/or one or more magnet and metal plate pairs.

It should be understood that while the description provided herein includes an OIS carrier for providing OIS movement of an optical assembly (for example, a lens carrier), the OIS carrier may alternatively be used for OIS movement of image sensor. For example, an image sensor may rest and/or be fixedly attached to an object side surface of the OIS carrier or within the center portion of the OIS carrier so that the OIS carrier may move the image sensor in the x-direction and/or the y-direction as described herein with respect to the optical assembly. Additionally, or alternatively, the lens carrier may be replaced with an image sensor carrier that retains the image sensor and rests on the OIS carrier. The OIS carrier retaining the image sensor carrier resting thereon may move in the x-direction and the y-direction for OIS motion of the image sensor. Additionally, the image sensor carrier may move in the z-direction relative to the OIS carrier via an AF actuator and AF ball bearings, raceways, and tracks for AF motion of the image sensor. In some embodiments, while the lens carrier may be replaced by the image sensor carrier for AF movement of the image sensor instead of AF movement of the lens carrier, a lens carrier or lens barrel may be positioned on an object side of the image sensor and image sensor carrier.

Reference will now be made in detail to embodiments, examples of which are illustrated in the accompanying drawings. In the following detailed description, numerous specific details are set forth in order to provide a thorough understanding of the present disclosure. However, it will be apparent to one of ordinary skill in the art that some embodiments may be practiced without these specific details. In other instances, well-known methods, procedures, components, circuits, and networks have not been described in detail so as not to unnecessarily obscure aspects of the embodiments.

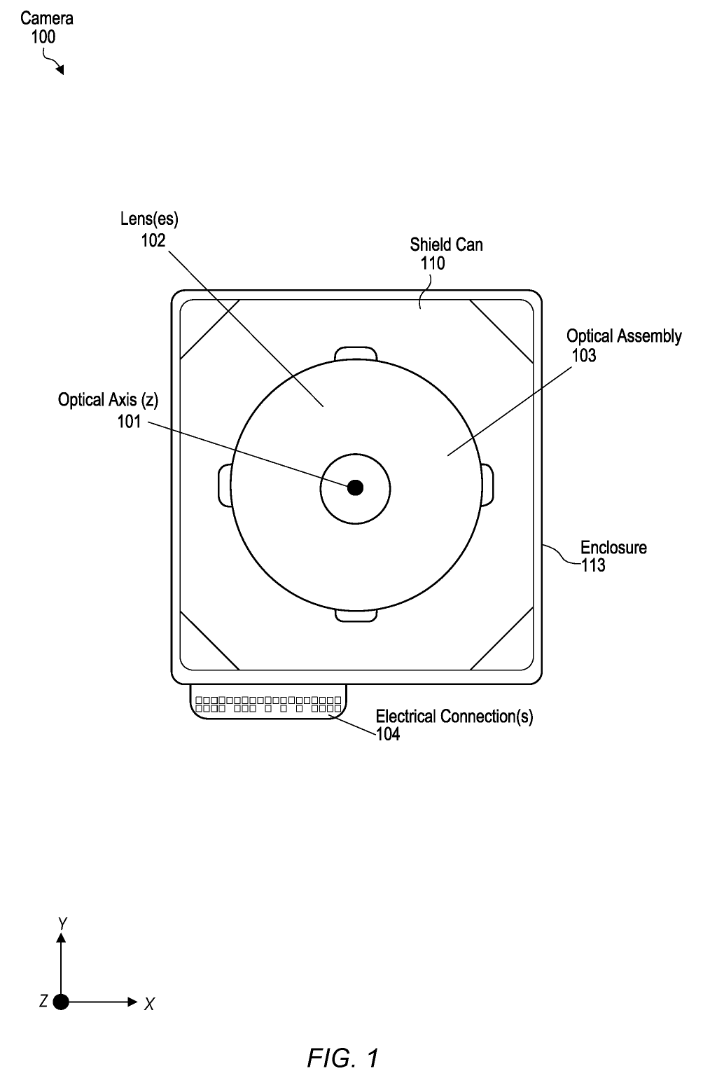

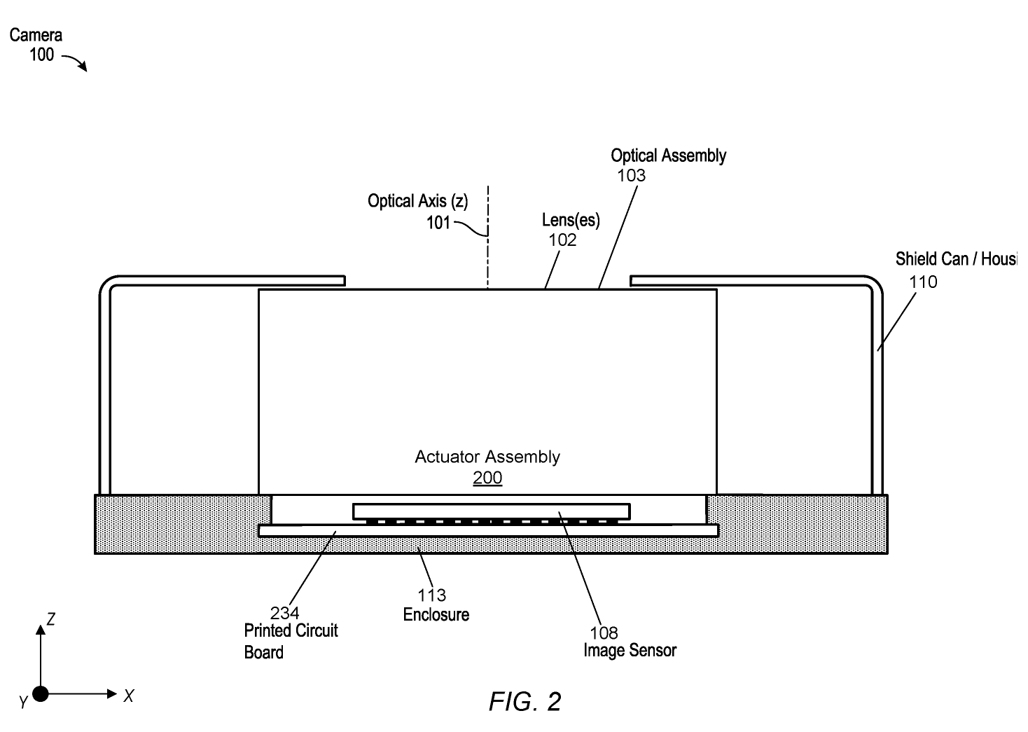

FIG. 1 illustrates components of an example camera 100 having an actuator module or assembly that may, for example, be used to provide autofocus (AF) and optical image stabilization (OIS) through lens movement in small form factor cameras, according to at least some embodiments. FIG. 1 shows an overhead view of the exterior of the camera 100.The camera 100 may include one or more same or similar features as the features described with respect to or illustrated in FIGS. 2, 3, 4, 5, 6, 7, 8a, 8b, 8c, 9, 10, 11, 12, 13, 14, 15, 16, 17, 18, and 19. The example X-Y-Z coordinate system shown in FIG. 1 may be used to discuss aspects of components and/or systems, and may apply to embodiments described throughout this disclosure.

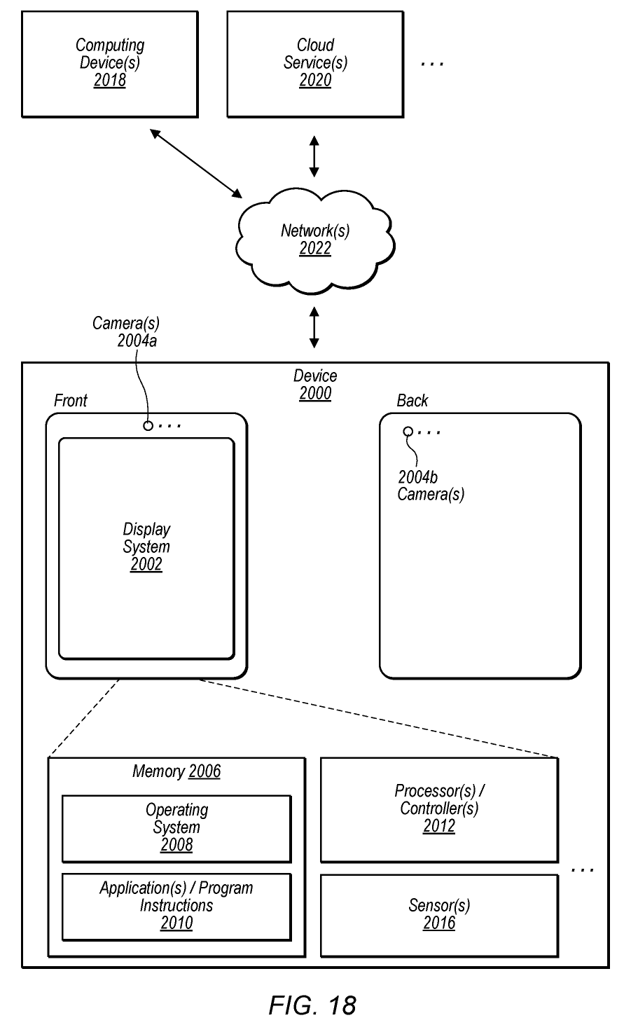

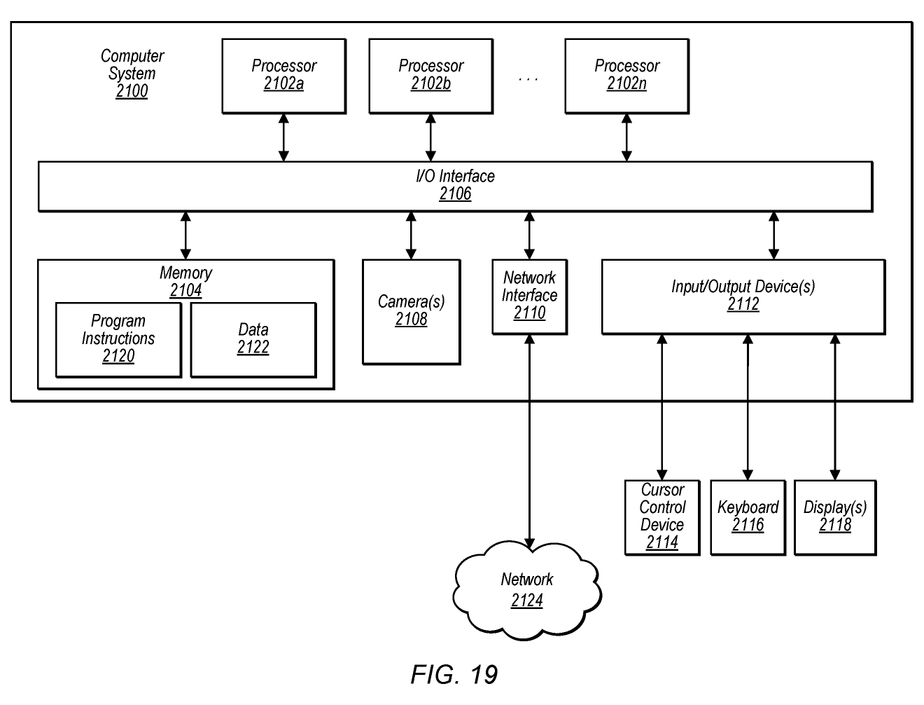

In various embodiments, the camera 100 may include an optical assembly 103 having one or more lenses 102 defining an optical axis (z) 101, a shield can 110, an enclosure 113, and electrical connection(s) 104. The shield can 110 may form an outer wall of a top portion (and in some cases side portions) of the camera 100 and form one or more camera shoulders. The enclosure 113 may form an outer wall of a bottom portion of the camera 100. The electrical connection(s) 104 may extend from the enclosure 113 (and shield can 110) and may electrically connect the camera 100 to an external device. For example, the camera 100 may be the same or similar camera as the camera 1804b illustrated in FIG. 18 or the camera 1908 illustrated in FIG. 19. As such, the electrical connection(s) 104 may extend from the enclosure 113 and may electrically connected the camera 100 to the device 1800 illustrated in FIG. 18 or the computer system 1900 illustrated in FIG. 19, respectively. In some aspects, the shield can 110 may be mechanically coupled to a base via the enclosure 113 attached to both the shield can 110 and the base. As describe herein, the camera 100 may include AF and OIS of the optical assembly.

FIG. 2 illustrates components of an example camera 100 having an actuator module or assembly that may, for example, be used to provide AF and OIS through lens movement in small form factor cameras, according to at least some embodiments. FIG. 2 shows a cross-sectional view of the camera 100. The camera 100 may include one or more same or similar features as the features described with respect to or illustrated in FIGS. 1, 3, 4, 5, 6, 7, 8a, 8b, 8c, 9, 10, 11, 12, 13, 14, 15, 16, 17, 18, and 19. The example X-Y-Z coordinate system shown in FIG. 2 may be used to discuss aspects of components and/or systems, and may apply to embodiments described throughout this disclosure.

As shown in FIG. 2, the camera 100 may include an optical assembly 103 including one or more lenses 102 centered on an optical axis (z) 101, a shield can 110, a printed circuit board (or a substrate) 234, an image sensor 108, a plurality of position sensors 230, the enclosure 113, and the actuator assembly 200. The shield can 110 coupled to the enclosure 113 may contain the actuator assembly 200, the printed circuit board 234, the image sensor 108, and the plurality of position sensors 230. The actuator assembly 200 may be attached to the optical assembly 103 for moving the optical assembly 103 for moving the optical assembly for AF and OIS, as described herein.

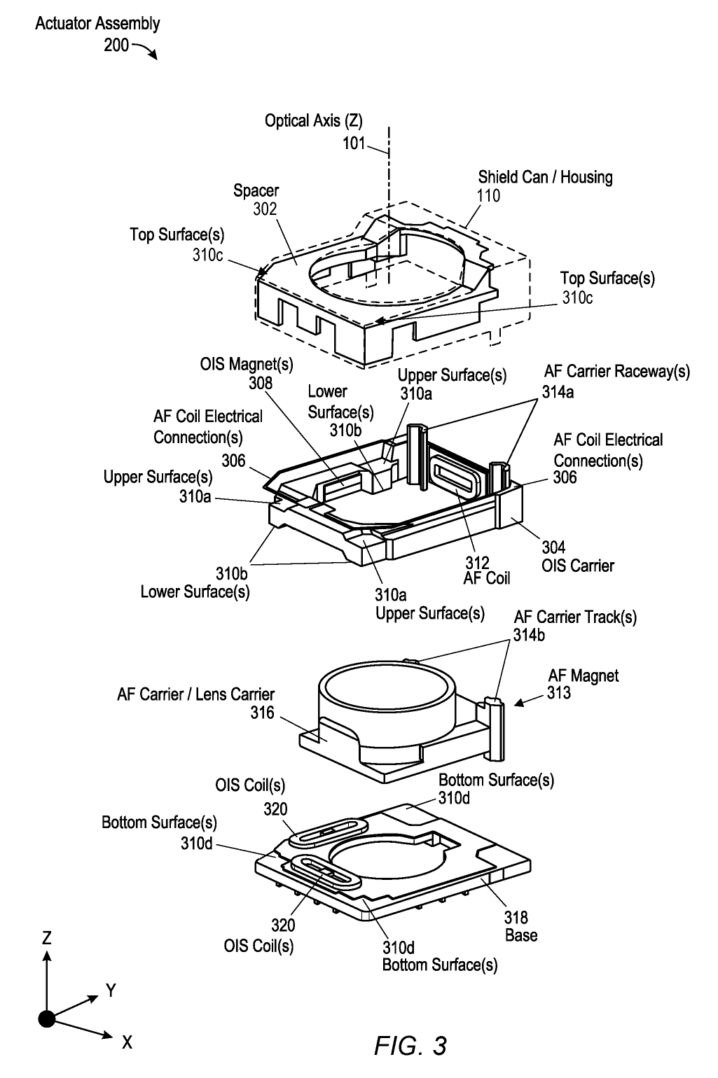

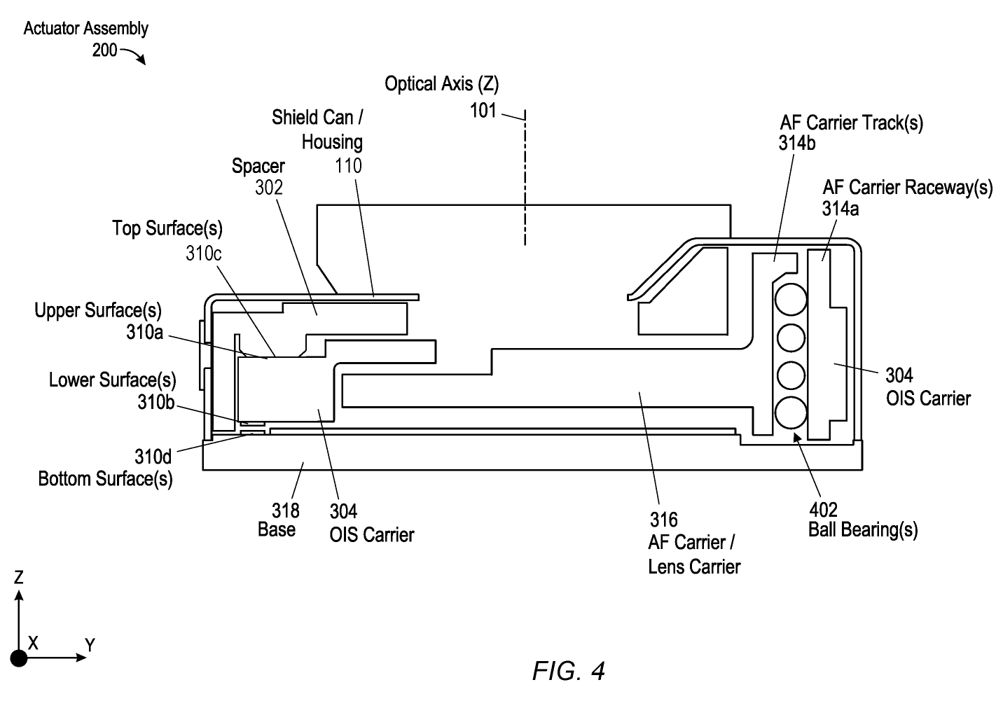

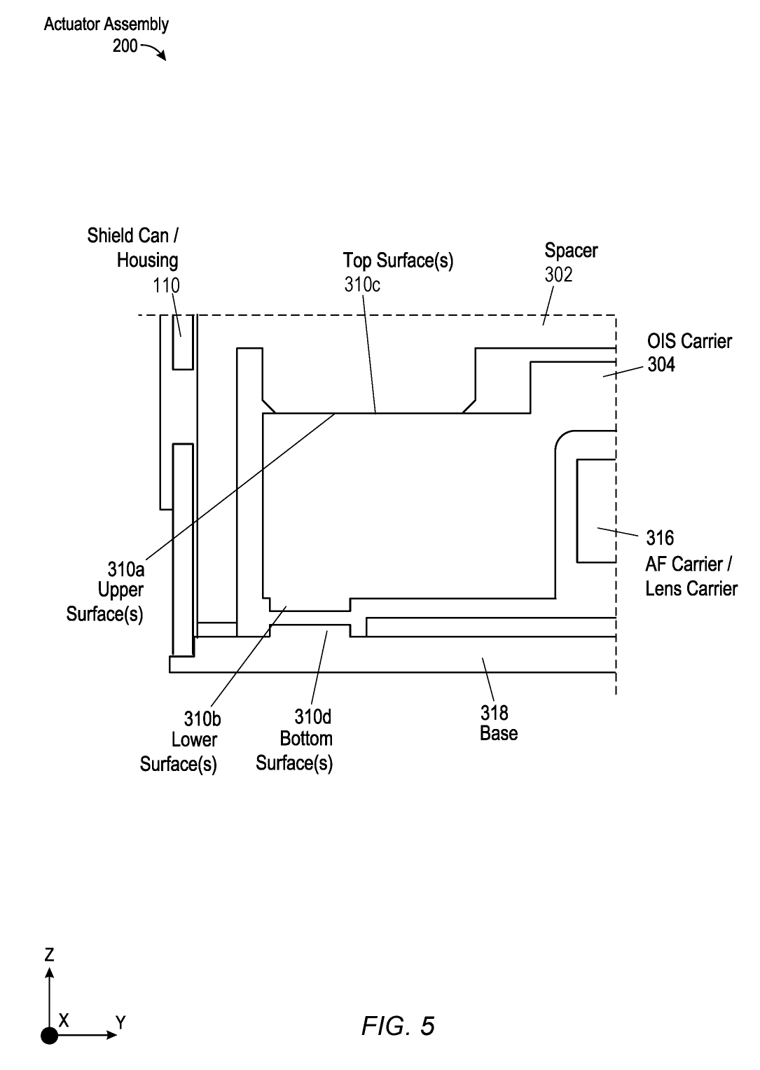

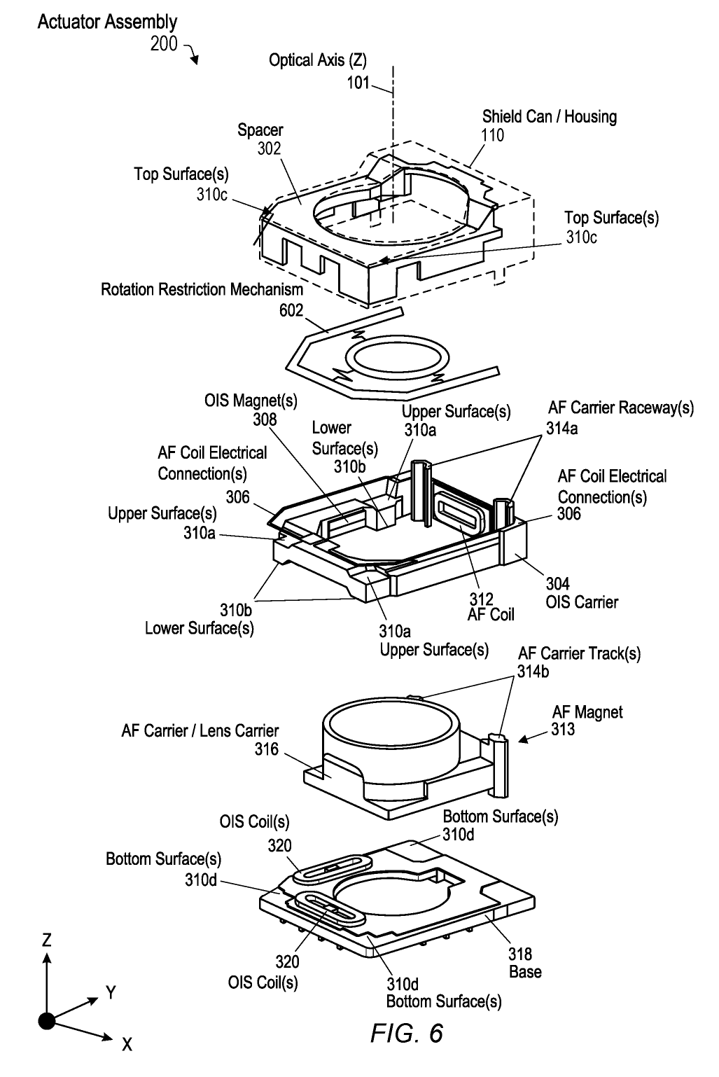

FIG. 3 illustrates components of an example actuator module or assembly 200 that may, for example, be used to provide AF and OIS through lens movement in small form factor cameras, according to at least some embodiments. FIG. 3 shows an exploded perspective view of the actuator module or assembly 200. FIG. 4 illustrates components of an example actuator module or assembly 200 that may, for example, be used to provide AF and OIS through lens movement in small form factor cameras, according to at least some embodiments. FIG. 4 shows a cross-sectional view of the actuator module or assembly 200. FIG. 5 illustrates components of an example actuator module or assembly 200 that may, for example, be used to provide AF and OIS through lens movement in small form factor cameras, according to at least some embodiments. FIG. 5 shows a cross-sectional view of the actuator module or assembly 200. FIG. 6 illustrates components of an example actuator module or assembly 200 that may, for example, be used to provide AF and OIS through lens movement in small form factor cameras, according to at least some embodiments. FIG. 6 shows an exploded perspective view of the actuator module or assembly 200. The actuator assembly 200 may include one or more same or similar features as the features described with respect to or illustrated in FIGS. 1, 2, 7, 8a, 8b, 8c, 9, 10, 11, 12, 13, 14, 15, 16, 17, 18, and 19. The example X-Y-Z coordinate system shown in FIGS. 3, 4, 5, and 6 may be used to discuss aspects of components and/or systems, and may apply to embodiments described throughout this disclosure.

As shown in FIG. 3, an actuator module or assembly 200 for a camera is provided and has a single carrier and OIS actuators for OIS movement of the optical assembly 103. The actuator assembly 200 may include a single OIS carrier 304 having an aperture extending therethrough for receiving a lens carrier or AF carrier 316. The lens carrier 316 having one or more lenses may rest on one or more surfaces of the OIS carrier 304 so that the lens carrier 316 moves with the OIS carrier 304 in the x and y directions for OIS movement of the lens carrier 316. In some aspects, the OIS carrier 304 may have a pair of vertical raceways 314a that are paired with a pair of vertical carrier tracks 314b of the lens carrier 316. The vertical raceways 314a and vertical carrier tracks 314b paired together may each contain one or more ball bearings 402 (for example, illustrated in FIG. 4). Because the lens carrier 316 rests on and/or within the OIS carrier 304, the lens carrier 316 may move vertically along in the z direction (for example, along the optical axis 101) relative to the OIS carrier 304 for AF using the pairs of vertical raceways 314a and vertical carrier tracks 314b (with the ball bearings 402) as guides. In some aspects, the lens carrier 316 may be fixedly attached to the OIS carrier 304, for example, when the camera module does not implement AF lens shift.

The OIS carrier 304 may be vertically positioned (for example, along an optical axis 101) between a shield can / housing 110 and a base 318. The housing 110 may include a spacer 302 with one or more top surfaces 310c for engaging with (for example, make physical contact with) one or more respective upper surfaces 310a of the OIS carrier 304. In some aspects, the engaging may be for sliding movement between two flat surfaces or rolling movement between a flat surface and a rounded surface. Pre-load magnets positioned within the housing 110 and/or within the spacer 302 that are vertically aligned with OIS magnets 308 attached to the OIS carrier 304 may bias the OIS carrier 304 towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302. As shown in FIGS. 4 and 5, when the OIS carrier 304 is biased towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302, a gap may be formed between the OIS carrier 304 and the base 318 (for example, between the bottom surface(s) 310d of the base 318 and the lower surface(s) 310b of the OIS carrier 304) removing friction between the OIS carrier 304 and the base 318 may exist. Alternatively, the base 318 may include one or more bottom surfaces 310d for engaging with (for example, make physical contact with) one or more respective lower surfaces 310b of the OIS carrier 304. In some aspects, the engaging may be for sliding movement between two flat surfaces or rolling movement between a flat surface and a rounded surface. Pre-load magnets positioned within the base 318 that are vertically aligned with the OIS magnets 308 attached to the OIS carrier 304 may bias the OIS carrier 304 towards the base 318 to facilitate maintained engagement between the lower surface(s) 310b of the OIS carrier 304 and respective bottom surface(s) 310d of the base 318 for movement (for example, sliding movement) of the OIS carrier 304 in the x and y directions relative to the base 318.

As mentioned herein, the OIS carrier 308 may include OIS magnets 308. For example, the OIS carrier 304 may include an OIS magnet 308 positioned within an arm of the OIS carrier 304 and another OIS magnet 308 positioned in an adjacent arm of the OIS carrier 304. The arm may extend in a direction orthogonal to the adjacent arm. As such, one OIS magnet 308 in an arm may be for x direction OIS movement of the OIS carrier 304 and the lens carrier 316 and the other OIS magnet 308 in the adjacent arm may be for y direction OIS movement of the OIS carrier 304 and the lens carrier 316. The base 318 may be positioned below the OIS carrier 304 in the z direction (for example, along the optical axis 101). The base 318 may include OIS coils 320 with a boarder side of the OIS coils 320 facing the OIS carrier 304 for interacting with the OIS magnets 308. For instance, the base 318 may include an OIS coil 320 vertically aligned with an OIS magnet 308 positioned within the arm of the OIS carrier 304 and another OIS coil 320 vertically aligned with the other OIS magnet 308 positioned within the adjacent arm of the OIS carrier 304. When an OIS coil 320 receives electric current, the electric current passing through the OIS coil 320 interacts with the magnetic field produced by the vertically aligned OIS magnet 308 causing the OIS carrier 304 and the lens carrier 316 to move for OIS. For example, when one OIS coil 320 receives electric current, the electric current passing through the one OIS coil 320 interacts with the magnetic field produced by the vertically aligned OIS magnet 308 within one arm of the OIS carrier 304 causing the OIS carrier 304 and the lens carrier 316 to move, via sliding engagement between upper surface(s) 310a of the OIS carrier 304 and top surface(s) 310c of the spacer 302, in the x direction for OIS. As another example, when another OIS coil 320 receives electric current, the electric current passing through the other OIS coil 320 interacts with the magnetic field produced by the vertically aligned OIS magnet 308 within an adjacent arm of the OIS carrier 304 causing the OIS carrier 304 and the lens carrier 316 to move, via sliding engagement between upper surface(s) 310a of the OIS carrier 304 and top surface(s) 310c of the spacer 302, in the y direction for OIS. In some aspects, the spacer 302 and/or the housing 110 may include side walls for limiting the distance that the OIS carrier 304 can move in the x and y directions. In some aspects, each of the OIS coils 320 positioned on the base 318 may be paired with a position sensor for determining the relative position of the OIS carrier 304 in the x and y directions. For example, an OIS coil 320 interacting with an OIS magnet 308 for causing OIS movement of the OIS carrier 304 in the x direction may be paired with a position sensor to determine a relative position of the OIS carrier 304 and the lens carrier 316 in the x direction. As another example, another OIS coil 320 interacting with another OIS magnet 308 for causing OIS movement of the OIS carrier 304 in the y direction may be paired with another position sensor to determine a relative position of the OIS carrier 304 and the lens carrier 316 in the y direction.

In some aspects and as described herein, the OIS carrier 304 may include a pair of vertical raceways 314a that are paired with a pair of vertical carrier tracks 314b on the lens carrier 316. The vertical raceways 314a and vertical carrier tracks 314b paired together may each contain one or more ball bearings 402. Because the lens carrier 316 rests on and/or within the OIS carrier 304 (and is not fixedly attached to the OIS carrier 304), the lens carrier 316 may move vertically along in the z direction (for example, along the optical axis 101) relative to the OIS carrier 316 for AF using the pairs of vertical raceways 314a and vertical carrier tracks 314b containing the ball bearings 402 as guides. For AF movement of the lens carrier 316 relative to the OIS carrier 304, the OIS carrier 304 may include an AF coil 312. The AF coil 312 may be positioned on an arm of the OIS carrier 304, for example, opposite an arm of the OIS carrier 304 having one of the OIS magnets 308. Additionally, or alternatively, the AF coil 312 may be positioned between the AF carrier raceways 314a on an arm or wall of the OIS carrier 304. The OIS carrier 304 may also include AF coil electrical connection(s) 306 for providing electric current to the AF coil 312 from a stationary component of the camera. For example, as shown in FIG. 3, the AF coil electrical connection(s) 306 may be electrically connected to the AF coil 312 and may wrap along and over an outer perimeter of the OIS carrier 304 (for example, so as not to interfere with the lens carrier 316) for electrical connection with a stationary component of the camera that provides electric current. In some aspect, the AF coil electrical connections 306 may be a pair of AF coil electrical connections 306 with one AF coil electrical connection 306 that is electrically connected to the AF coil 312 and wraps along and over a half of an outer perimeter of the OIS carrier 304 on one side of the OIS carrier 304 and another AF coil electrical connection 306 that is also electrically connected to the AF coil 312 and wraps along and over another half of an outer perimeter of the OIS carrier 304 on an opposite side of the OIS carrier 304 so that both AF coil electrical connections 306 arrive at the same stationary component of the camera for a supply current and a return current, respectively. In some aspects, the AF coil electrical connection(s) 306 may flex to permit or allow OIS movement of the OIS carrier 304 while maintaining electrical connections with the AF coil 312 and the stationary component of the camera.

In addition, for AF movement of the lens carrier 316, the lens carrier 316 may include an AF magnet 313. The AF magnet 313 may be positioned on a wall or side surface of the lens carrier 316 so that when the lens carrier 316 is positioned with the OIS carrier 304, the AF magnet 313 may be adjacent to the AF coil 312 positioned with the OIS carrier 304. For example, the AF magnet 313 may be positioned on a wall or side surface of the lens carrier 316 that is not adjacent or next to an arm of the OIS carrier 304 that contains an OIS magnet 308 and instead contains the AF coil 312. Additionally, or alternatively, the AF magnet 313 may be positioned on a wall or side surface of the lens carrier and between the AF carrier tracks 314b on the lens carrier 316 so that the AF magnet 313 on the lens carrier 316 is positioned adjacent to the AF coil 312 on the OIS carrier 304. When the AF coil 312 on the OIS carrier 304 receives electric current from the stationary component of the camera and via the AF coil electrical connection(s) 306, the electric current passing through the AF coil 312 interacts with the magnetic field produced by the adjacent AF magnet 313 positioned on the lens carrier 316 causing the lens carrier to move for AF. For example, when the AF coil 312 on the OIS carrier 304 receives electric current from the stationary component of the camera and via the AF coil electrical connection(s) 306, the electric current passing through the AF coil 312 interacts with the magnetic field produced by the adjacent AF magnet 313 positioned on the lens carrier 316 causing the lens carrier 316 to move, via the ball bearing 402 within the paired AF carrier raceway(s) 314a and AF carrier tracks 314b, relative to the OIS carrier 304 in a z direction (for example, along the optical axis 101) away from the OIS carrier 304 and the base 318. As another example, when the AF coil on the OIS carrier receives electric current from the stationary component of the camera and via the AF coil electrical connection(s), the electric current interacts with the magnetic field produced by the adjacent AF magnet positioned on the lens carrier causing the lens carrier to move, via the ball bearing within the paired AF carrier tracks and AF carrier raceways, relative to the OIS carrier in a z direction (for example, along the optical axis) towards the OIS carrier and the base.

Due to movement of the lens carrier 316 in the x direction and/or the y direction for OIS, uncontrolled or inadvertent rotation of the lens carrier 316 about the optical axis 101 may occur. Uncontrolled rotation of the lens carrier 316 about the optical axis 101 may introduce position errors causing x and y accuracy and/or image quality degradation. As shown in FIG. 6, the actuator module or assembly 200 may additionally include a rotation restriction mechanism 602 for providing torsional or rotation stiffness to the lens carrier 316. For example, the rotation restriction mechanism 602 may be provided to the lens carrier 306 for introducing rotational stiffness of the lens carrier 316 about the optical axis 101 while providing little or no stiffness for OIS and AF movement of the lens carrier 316. For instance, the rotation restriction mechanism 602 may be fixedly attached to the housing 110 and fixedly attached to at least one of the lens carrier 316 or the OIS carrier 304. Alternatively, the rotation restriction mechanism 602 may be fixedly attached to the OIS carrier 304 and fixedly attached the lens carrier 316. The rotation restriction mechanism 602 may allow for OIS and/or AF movement of the lens carrier 316 while restricting rotational movement of the lens carrier 316 (and the OIS carrier 304) about the optical axis 101. In some aspects, for OIS and/or AF sensor shift embodiments, the rotation restriction mechanism 602 may allow for OIS and/or AF movement of the image sensor (for example, an image sensor carrier and image sensor) while restricting rotational movement of the image sensor (for example, an image sensor carrier and image sensor) the about the optical axis 101.

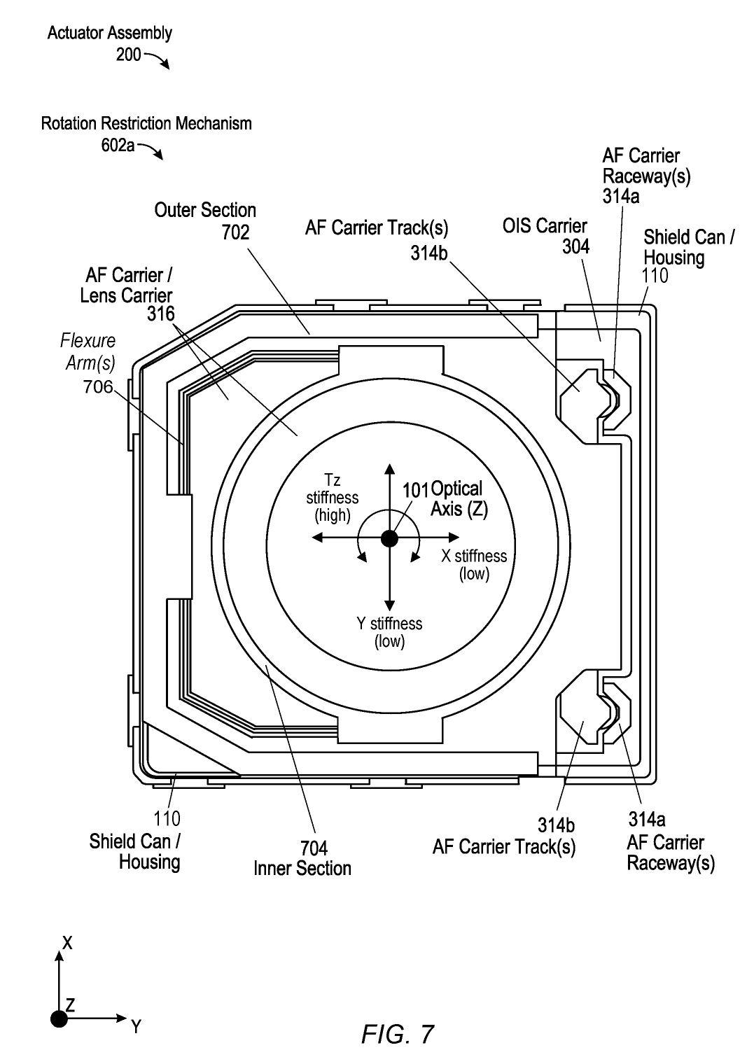

FIG. 7 illustrates components of an example rotation restriction mechanism 602a of actuator module or assembly that may, for example, be used to provide AF and OIS through lens movement in small form factor cameras, according to at least some embodiments. FIG. 7 shows an overhead view of the rotation restriction mechanism 602a of actuator module or assembly. The rotation restriction mechanism 602a may include one or more same or similar features as the features described with respect to or illustrated in FIGS. 1, 2, 3, 4, 5, 6, 8a, 8b, 8c, 9, 10, 11, 12, 13, 14, 15, 16, 17, 18, and 19. The example X-Y-Z coordinate system shown in FIG. 7 may be used to discuss aspects of components and/or systems, and may apply to embodiments described throughout this disclosure.

As described herein, due to movement of the lens carrier 316 in the x direction and/or the y direction for OIS, uncontrolled or inadvertent rotation of the lens carrier 316 about the optical axis 101 may occur. Uncontrolled rotation of the lens carrier 316 about the optical axis 101 may introduce position errors causing x and y accuracy and/or image quality degradation. As shown in FIG. 7, the actuator module or assembly 200 may additionally include a rotation restriction mechanism 602a for providing torsional or rotation stiffness to the lens carrier 316. For example, the rotation restriction mechanism 602s may be provided to the lens carrier 306 for introducing rotational stiffness of the lens carrier 316 about the optical axis 101 while providing little or no stiffness for OIS and/or AF movement of the lens carrier 316. For instance, the rotation restriction mechanism 602a may be fixedly attached to the housing 110 at an outer section 702 of the rotation restriction mechanism 602a and fixedly attached to at least one of the lens carrier 316 or the OIS carrier 304 at an inner section 704 of the rotation restriction mechanism 602a. Alternatively, the rotation restriction mechanism 602a may be fixedly attached to the OIS carrier 304 at an outer section 702 of the rotation restriction mechanism 602a and fixedly attached the lens carrier 316 at an inner section 704 of the rotation restriction mechanism 602a. The outer section 704 may be static or stationary compared to the inner section 702 which moves with one or more moving components of the actuator assembly (for example, the OIS carrier 304 and/or the lens carrier 316). One or more flexure arms 706, each extending between the outer section 702 and the inner section 704, may allow for OIS and/or AF movement of the lens carrier 316 (and the OIS carrier 304) while restricting rotational movement of the lens carrier 316 (and the OIS carrier 304) about the optical axis 101. In some aspects, the one or more flexure arms 706 may include one or more springs for allowing OIS and/or AF movement of the lens carrier 316 (and the OIS carrier 304) while restricting rotational movement of the lens carrier 316 (and the OIS carrier 304) about the optical axis 101. In some aspects, one or more flexure arm(s) 706 may include electrical trace(s) therein or thereon for providing electrical communication between the outer section 702 and the inner section 704. When, for example, the rotation restriction mechanism 602a is attached to both a static component of the camera and the OIS carrier, the electrical trace(s) may be used to supply electrical power to an AF coil, for example, positioned on the OIS carrier 304 for AF movement of the lens carrier 316. The rotation restriction mechanism 602a may allow for OIS and/or AF movement of the lens carrier 316 while restricting rotational movement of the lens carrier 316 (and the OIS carrier 304) about the optical axis 101.

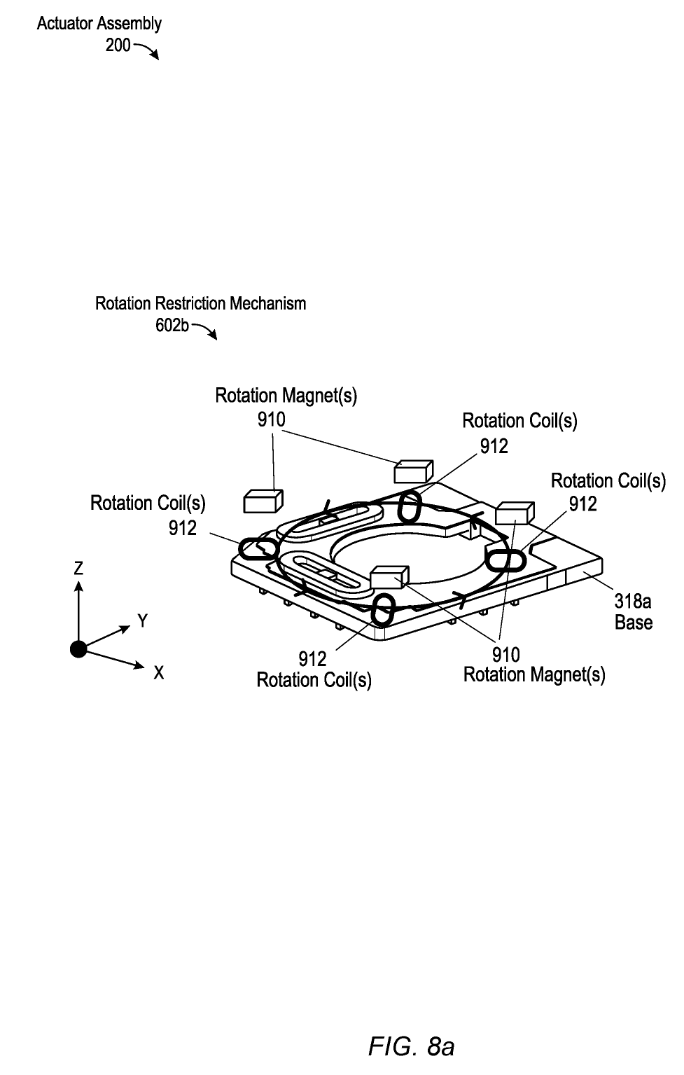

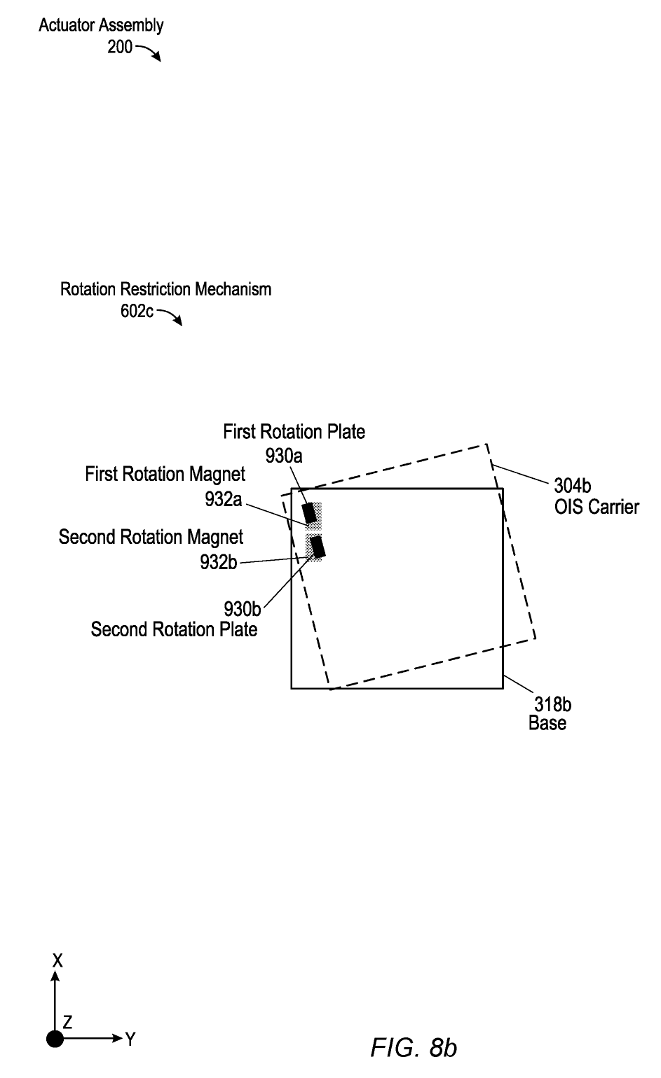

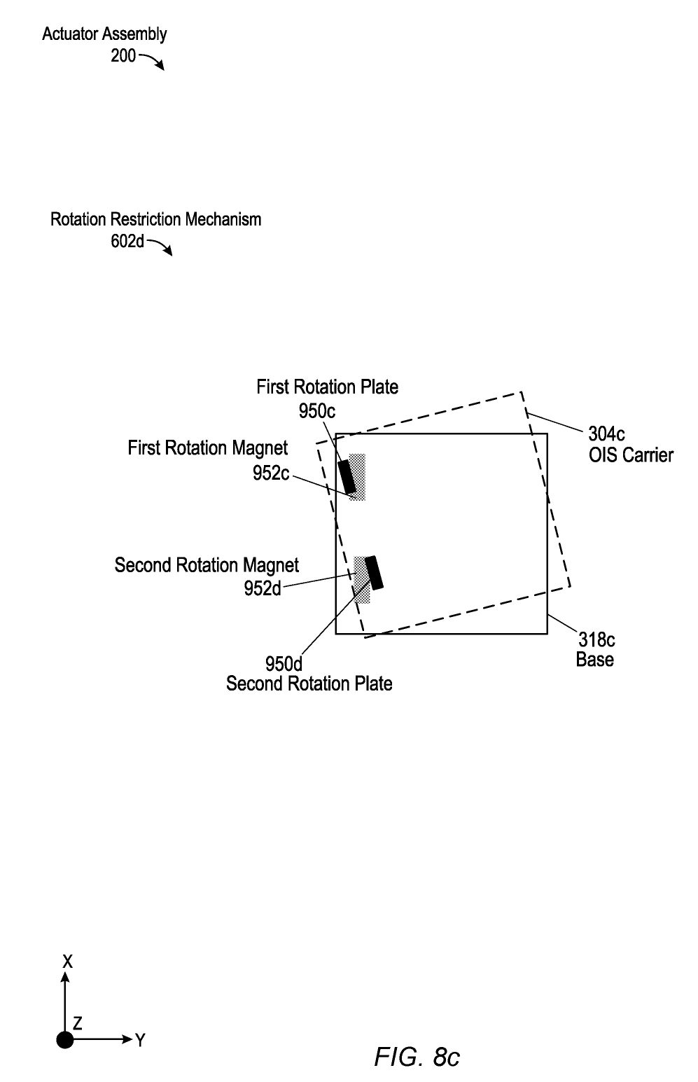

FIG. 8a illustrates components of an example rotation restriction mechanism 602b for an actuator module or assembly that may, for example, be used to provide AF and OIS through lens movement in small form factor cameras, according to at least some embodiments. FIG. 8a shows a perspective view of the rotation restriction mechanism 602b. The rotation restriction mechanism 602b may include one or more same or similar features as the features described with respect to or illustrated in FIGS. 1, 2, 3, 4, 5, 6, 7, 8b, 8c, 9, 10, 11, 12, 13, 14, 15, 16, 17, 18, and 19. The example X-Y-Z coordinate system shown in FIG. 8a may be used to discuss aspects of components and/or systems, and may apply to embodiments described throughout this disclosure.

As described herein, due to movement of the lens carrier 316 in the x direction and/or the y direction for OIS, uncontrolled or inadvertent rotation of the lens carrier 316 about the optical axis 101 may occur. Uncontrolled rotation of the lens carrier 316 about the optical axis 101 may introduce position errors causing x and y accuracy and/or image quality degradation. In addition to or as an alternative to the rotation restriction mechanism 602 or 602a, the actuator assembly 200 may include rotation restriction mechanism 602b to correct uncontrolled or inadvertent rotation of the lens carrier 316 about the optical axis 101. For instance, four pairs of rotation magnets 910 and rotation coils 912 may be used to correct uncontrolled or inadvertent rotation of the lens carrier 316 about the optical axis 101. As shown in FIG. 8a, the base 318a may include a plurality of rotation coils 912 positioned in corners of the base 318a. Rotation magnets 910 may be fixedly attached to a side of an OIS carrier facing the base 318a so that the rotation magnets 910 are vertically aligned with the rotation coils 912. When uncontrolled or inadvertent rotation of the lens carrier 316 and OIS carrier 304 about the optical axis 101 occurs, electric current may be provided through one or more of the rotation coils 912 so that electric current passing through the one or more rotation coils 912 may interact with magnetic fields from respective rotation magnets 910 to rotate the OIS carrier 304 so that the OIS carrier 304 is rotationally aligned with the base 318a. In some aspects, the rotation magnets 910 and the rotation coils 912 may be used in addition to or as an alternative to the OIS magnets 308 and OIS coils 320 described herein.

FIG. 8b illustrates components of an example rotation restriction mechanism 602c for an actuator module or assembly that may, for example, be used to provide AF and OIS through lens movement in small form factor cameras, according to at least some embodiments. FIG. 8b shows a perspective view of the rotation restriction mechanism 602c. The rotation restriction mechanism 602c may include one or more same or similar features as the features described with respect to or illustrated in FIGS. 1, 2, 3, 4, 5, 6, 7, 8a, 8c, 9, 10, 11, 12, 13, 14, 15, 16, 17, 18, and 19. The example X-Y-Z coordinate system shown in FIG. 8b may be used to discuss aspects of components and/or systems, and may apply to embodiments described throughout this disclosure.

In some aspects, the rotation restriction mechanism 602c may include one or more pairs of magnets and plates. For example, as shown in FIG. 8b, the rotation restriction mechanism 602c may include a first rotation plate 930a, a second rotation plate 930b, a first rotation magnet 932a, and a second rotation magnet 932b. A base 318b may include the first rotation magnet 932a and the second rotation magnet 932b attached thereto in a same corner of the base 318b. A first rotation plate 930a (for example, a metal plate receptive for attraction to or repulsion from a magnet via a magnet field of the magnet) and a second rotation plate 930b (for example, a metal plate receptive for attraction to or repulsion from a magnet via a magnet field of the magnet) may be attached to a same corner of the OIS carrier 304b and a same side of the OIS carrier 304b facing the base 318b so that the first rotation plate 930a is vertically aligned with and adjacent the first rotation magnet 932a and the second rotation plate 930b is vertically aligned with and adjacent the second rotation magnet 932b. When uncontrolled or inadvertent rotation of the lens carrier 316 and OIS carrier 304b about the optical axis 101 occurs, the first rotation plate 930a may interact with the magnetic field from the first rotation magnet 932a and the second rotation plate 930b may interact with the magnetic field the second rotation magnet 932b so that the OIS carrier 304b moves, pulls, holds, or snaps back into alignment with the base 318b.

FIG. 8c illustrates components of an example rotation restriction mechanism 602d for an actuator module or assembly that may, for example, be used to provide AF and OIS through lens movement in small form factor cameras, according to at least some embodiments. FIG. 8c shows a perspective view of the rotation restriction mechanism 602d. The rotation restriction mechanism 602d may include one or more same or similar features as the features described with respect to or illustrated in FIGS. 1, 2, 3, 4, 5, 6, 7, 8a, 8b, 9, 10, 11, 12, 13, 14, 15, 16, 17, 18, and 19. The example X-Y-Z coordinate system shown in FIG. 8c may be used to discuss aspects of components and/or systems, and may apply to embodiments described throughout this disclosure.

In some aspects, the rotation restriction mechanism 602d may include one or more pairs of magnets and plates. For example, as shown in FIG. 8c, the rotation restriction mechanism 602d may include a first rotation plate 950a, a second rotation plate 950b, a first rotation magnet 952a, and a second rotation magnet 952b. A base 318c may include the first rotation magnet 952a and the second rotation magnet 952b attached thereto in adjacent corners of the base 318c. A first rotation plate 950a(for example, a metal plate receptive for attraction to or repulsion from a magnet via a magnet field of the magnet) and a second rotation plate 950b (for example, a metal plate receptive for attraction to or repulsion from a magnet via a magnet field of the magnet) may be attached to adjacent corners of the OIS carrier 304c and a same side of the OIS carrier 304c facing the base 318c so that the first rotation plate 950a is vertically aligned with and adjacent the first rotation magnet 952a and the second rotation plate 950b is vertically aligned with and adjacent the second rotation magnet 952b. When uncontrolled or inadvertent rotation of the lens carrier 316 and OIS carrier 304c about the optical axis 101 occurs, the first rotation plate 950a may interact with the magnetic field from the first rotation magnet 952a and the second rotation plate 950b may interact with the magnetic field the second rotation magnet 952b so that the OIS carrier 304c moves, pulls, holds, or snaps back into alignment with the base 318c.

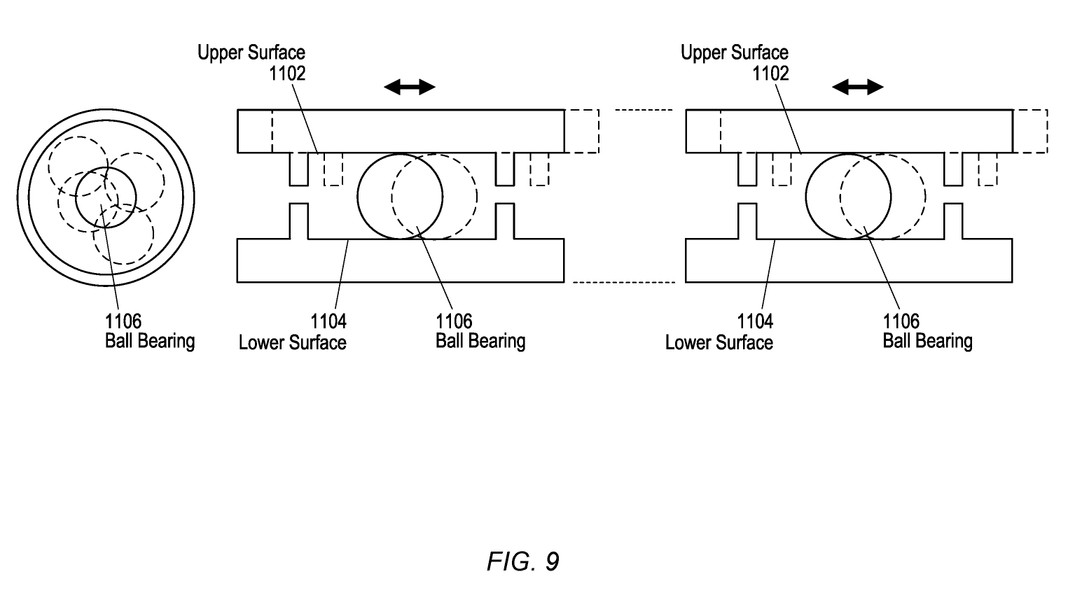

FIG. 9 illustrates components of OIS carrier surfaces that may, for example, be used to provide OIS through lens movement in small form factor cameras, according to at least some embodiments. FIG. 9 shows an overhead view and cross-sectional views of the OIS carrier surfaces. The features described and/or illustrated in FIG. 9 may include one or more same or similar features as the features described with respect to or illustrated in FIGS. 1, 2, 3, 4, 5, 6, 7, 8a, 8b, 8c, 10, 11, 12, 13, 14, 15, 16, 17, 18, and 19. The example X-Y-Z coordinate system shown in FIG. 9 may be used to discuss aspects of components and/or systems, and may apply to embodiments described throughout this disclosure.

As described herein, the OIS carrier 304 may be vertically positioned (for example, along an optical axis 101) between the housing 110 and the base 318. The housing 110 may include a spacer 302 with one or more top surfaces 310c for engaging with (for example, make physical contact with) one or more respective upper surfaces 310a of the OIS carrier 304. In some aspects, the engaging may be for sliding movement between two flat surfaces or rolling movement between a flat surface and a rounded surface. Pre-load magnets positioned within the housing 110 and/or within the spacer 302 that are vertically aligned with OIS magnets 308 attached to the OIS carrier 304 may bias the OIS carrier 304 towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302. In some aspects, the top surface(s) 310c may include an upper surface 1102 (as shown in FIG. 9) and the upper surface(s) 310a may include a lower surface 1104 (as shown in FIG. 9). Also, as shown in FIG. 9, one or more ball bearings 1006 may be positioned between the upper surface 1102 and the lower surface 1104. Because the upper surface 1102 and the lower surface 1104 are flat surfaces, the ball bearings 1106 may roll in an x-y plane. Thus, using the upper surface 1102, lower surface 1104, and the ball bearings 1106 with the OIS carrier 304 and the housing 110, the OIS carrier 304 may be allowed to move in both the x direction and the y direction for OIS movement of the lens carrier 316.

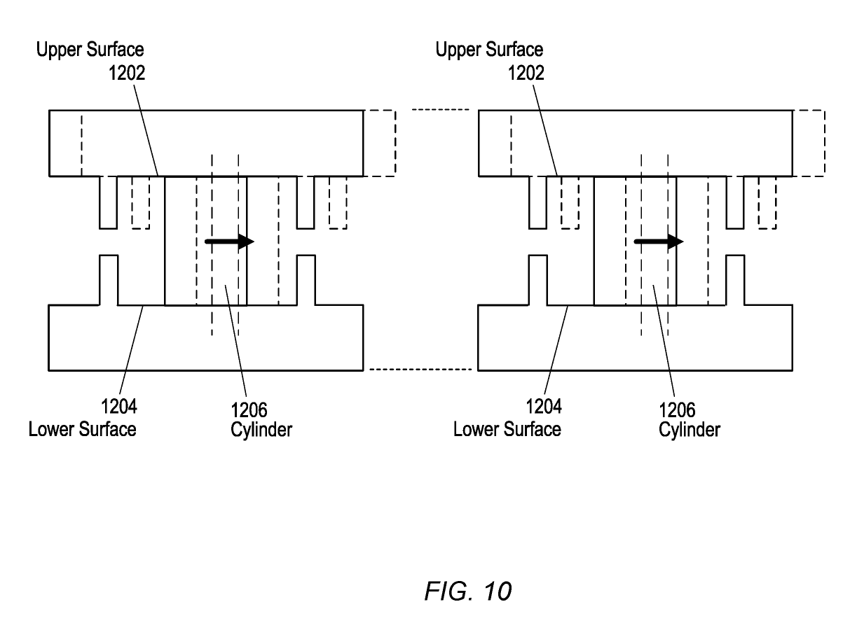

FIG. 10 illustrates components of other OIS carrier surfaces that may, for example, be used to provide OIS through lens movement in small form factor cameras, according to at least some embodiments. FIG. 10 shows cross-sectional views of the OIS carrier surfaces. The features described and/or illustrated in FIG. 10 may include one or more same or similar features as the features described with respect to or illustrated in FIGS. 1, 2, 3, 4, 5, 6, 7, 8a, 8b, 8c, 9, 11, 12, 13, 14, 15, 16, 17, 18, and 19. The example X-Y-Z coordinate system shown in FIG. 10 may be used to discuss aspects of components and/or systems, and may apply to embodiments described throughout this disclosure.

As described herein, the OIS carrier 304 may be vertically positioned (for example, along an optical axis 101) between the housing 110 and the base 318. The housing 110 may include a spacer 302 with one or more top surfaces 310c for engaging with (for example, make physical contact with) one or more respective upper surfaces 310a of the OIS carrier 304. In some aspects, the engaging may be for sliding movement between two flat surfaces or rolling movement between a flat surface and a rounded surface. Pre-load magnets positioned within the housing 110 and/or within the spacer 302 that are vertically aligned with OIS magnets 308 attached to the OIS carrier 304 may bias the OIS carrier 304 towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302. In some aspects, the top surface(s) 310c may include an upper surface 1202 (as shown in FIG. 10) and the upper surface(s) 310a may include a lower surface 1204 (as shown in FIG. 10). Also, as shown in FIG. 10, a cylinder 1206 may be positioned between the upper surface 1202 and the lower surface 1204. Because the upper surface 1202 and the lower surface 1204 are flat surfaces, the cylinder 1206 may slide in an x-y plane. Thus, using the upper surface 1202, lower surface 1204, and the cylinder 1206 with the OIS carrier 304 and the housing 110, the OIS carrier 304 may be allowed to move in both the x direction and the y direction for OIS movement of the lens carrier 316.

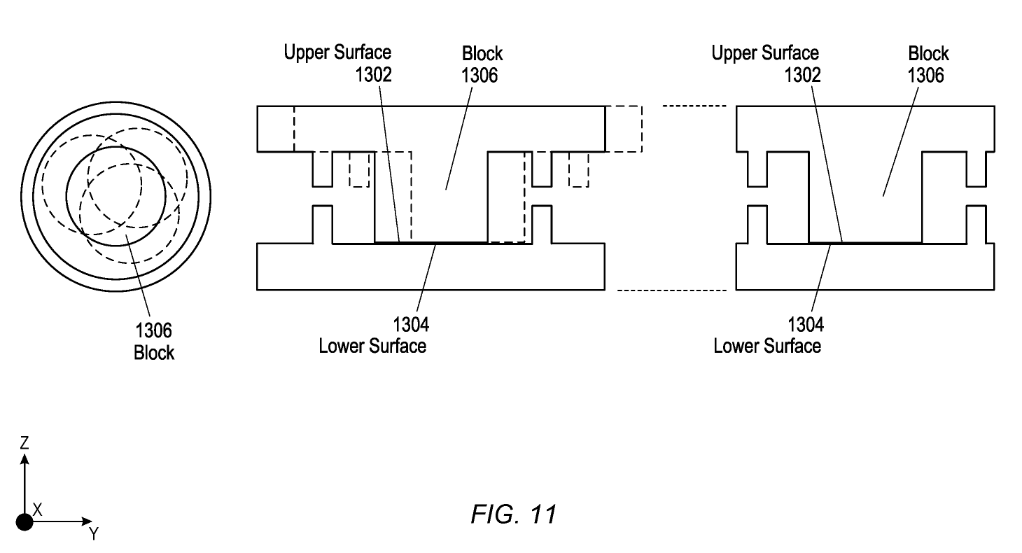

FIG. 11 illustrates components of yet other OIS carrier surfaces that may, for example, be used to provide OIS through lens movement in small form factor cameras, according to at least some embodiments. FIG. 11 shows an overhead view and cross-sectional views of the OIS carrier surfaces. The features described and/or illustrated in FIG. 11 may include one or more same or similar features as the features described with respect to or illustrated in FIGS. 1, 2, 3, 4, 5, 6, 7, 8a, 8b, 8c, 9, 10, 12, 13, 14, 15, 16, 17, 18, and 19. The example X-Y-Z coordinate system shown in FIG. 11 may be used to discuss aspects of components and/or systems, and may apply to embodiments described throughout this disclosure.

As described herein, the OIS carrier 304 may be vertically positioned (for example, along an optical axis 101) between the housing 110 and the base 318. The housing 110 may include a spacer 302 with one or more top surfaces 310c for engaging with (for example, make physical contact with) one or more respective upper surfaces 310a of the OIS carrier 304. In some aspects, the engaging may be for sliding movement between two flat surfaces or rolling movement between a flat surface and a rounded surface. Pre-load magnets positioned within the housing 110 and/or within the spacer 302 that are vertically aligned with OIS magnets 308 attached to the OIS carrier 304 may bias the OIS carrier 304 towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302. In some aspects, the top surface(s) 310c may include an upper surface 1302 formed by a block 1306 (as shown in FIG. 11) and the upper surface(s) 310a may include a lower surface 1304 (as shown in FIG. 11). Also, as shown in FIG. 11, the block 1306 may be positioned against the lower surface 1204 for sliding contact with the lower surface 1304. Because the upper surface 1302 on the block 1306 and the lower surface 1304 are flat surfaces, the block 1306 may slide in an x-y plane. The upper surface 1302 and the lower surface 1304 may include surfaces with friction as low as possible for sliding movement. In some aspects, the material forming the upper surface 1302 may be a polymer that is suited for low wear and low friction applications (for example, nylon, acetal, HDPE) and the material forming the lower surface 1302 may be a polymer such as LCP or PPA for low friction sliding between the two engaged surfaces. Thus, using the upper surface 1302 of the block 1306 and lower surface 1304 with the OIS carrier 304 and the housing 110, the OIS carrier 304 may be allowed to move in both the x direction and the y direction for OIS movement of the lens carrier 316.

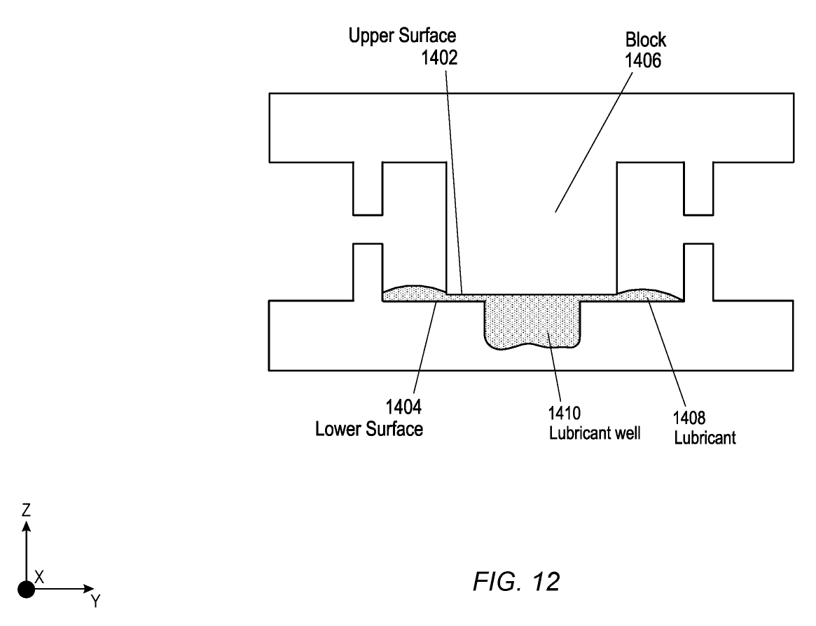

FIG. 12 illustrates components of yet other OIS carrier surfaces that may, for example, be used to provide OIS through lens movement in small form factor cameras, according to at least some embodiments. FIG. 12 shows an overhead view and cross-section views of the OIS carrier surfaces. The features described and/or illustrated in FIG. 12 may include one or more same or similar features as the features described with respect to or illustrated in FIGS. 1, 2, 3, 4, 5, 6, 7, 8a, 8b, 8c, 9, 10, 11, 13, 14, 15, 16, 17, 18, and 19. The example X-Y-Z coordinate system shown in FIG. 12 may be used to discuss aspects of components and/or systems, and may apply to embodiments described throughout this disclosure.

As described herein, the OIS carrier 304 may be vertically positioned (for example, along an optical axis 101) between the housing 110 and the base 318. The housing 110 may include a spacer 302 with one or more top surfaces 310c for engaging with (for example, make physical contact with) one or more respective upper surfaces 310a of the OIS carrier 304. In some aspects, the engaging may be for sliding movement between two flat surfaces or rolling movement between a flat surface and a rounded surface. Pre-load magnets positioned within the housing 110 and/or within the spacer 302 that are vertically aligned with OIS magnets 308 attached to the OIS carrier 304 may bias the OIS carrier 304 towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302. In some aspects, the top surface(s) 310c may include an upper surface 1402 formed by a block 1406 (as shown in FIG. 12) and the upper surface(s) 310a may include a lower surface 1404 (as shown in FIG. 12). Also, as shown in FIG. 12, the block 1406 may be positioned against the lower surface 1404 for sliding contact between the upper surface 1402 and the lower surface 1404. In addition, the lower surface 1404 may include lubricant 1408 positioned thereon and a lubricant well 1410 in the lower surface 1404 for supplying the lubricant 1408 onto the lower surface 1404. Because the upper surface 1402 on the block 1406 and the lower surface 1404 are flat surfaces, the block 1406 may slide in an x-y plane. The lubricant 1408 may create a low friction interaction between the upper surface 1402 and the lower surface 1404 for sliding movement. Thus, using the upper surface 1402 of the block 1406 and lower surface 1404 together with the lubricant 1408 and the lubricant well 1410 and with the OIS carrier 304 and the housing 110, the OIS carrier 304 may be allowed to move in both the x direction and the y direction for OIS movement of the lens carrier 316.

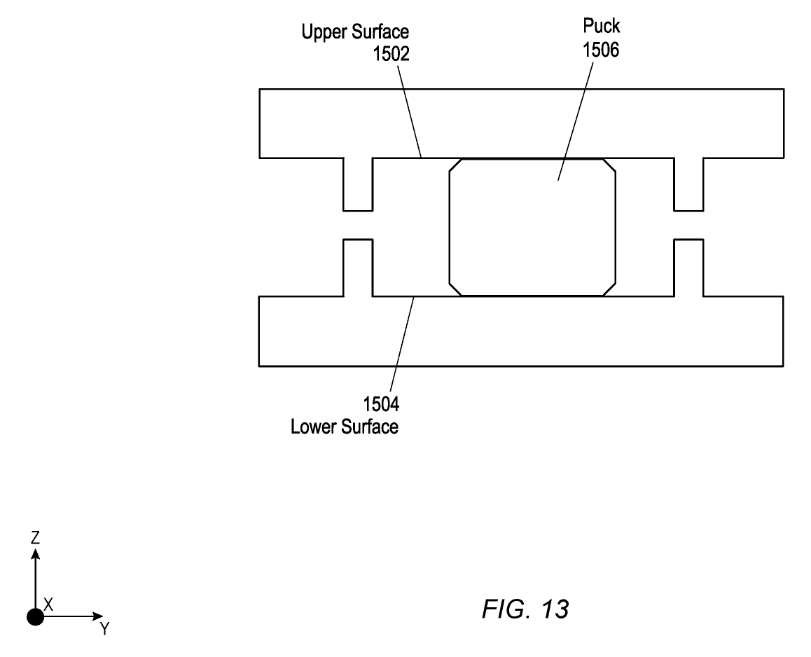

FIG. 13 illustrates components of yet other OIS carrier surfaces that may, for example, be used to provide OIS through lens movement in small form factor cameras, according to at least some embodiments. FIG. 13 shows a cross-sectional view of the OIS carrier surfaces. The features described and/or illustrated in FIG. 13 may include one or more same or similar features as the features described with respect to or illustrated in FIGS. 1, 2, 3, 4, 5, 6, 7, 8a, 8b, 8c, 9, 10, 11, 12, 14, 15, 16, 17, 18, and 19. The example X-Y-Z coordinate system shown in FIG. 13 may be used to discuss aspects of components and/or systems, and may apply to embodiments described throughout this disclosure.

As described herein, the OIS carrier 304 may be vertically positioned (for example, along an optical axis 101) between the housing 110 and the base 318. The housing 110 may include a spacer 302 with one or more top surfaces 310c for engaging with (for example, make physical contact with) one or more respective upper surfaces 310a of the OIS carrier 304. In some aspects, the engaging may be for sliding movement between two flat surfaces or rolling movement between a flat surface and a rounded surface. Pre-load magnets positioned within the housing 110 and/or within the spacer 302 that are vertically aligned with OIS magnets 308 attached to the OIS carrier 304 may bias the OIS carrier 304 towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302. In some aspects, the top surface(s) 310c may include an upper surface 1502 (as shown in FIG. 13) and the upper surface(s) 310a may include a lower surface 1504 (as shown in FIG. 13). Also, as shown in FIG. 13, a puck 1506 may be positioned between the upper surface 1502 and the lower surface 1504. The puck 1506 may include a low friction plastic material or a ceramic. Because the upper surface 1202 and the lower surface 1204 are flat surfaces and because the puck 1506 includes a low friction plastic material or a ceramic, the puck 1506 may slide in an x-y plane. Thus, using the upper surface 1502, lower surface 1504, and the puck 1506 with the OIS carrier 304 and the housing 110, the OIS carrier 304 may be allowed to move in both the x direction and the y direction for OIS movement of the lens carrier 316.

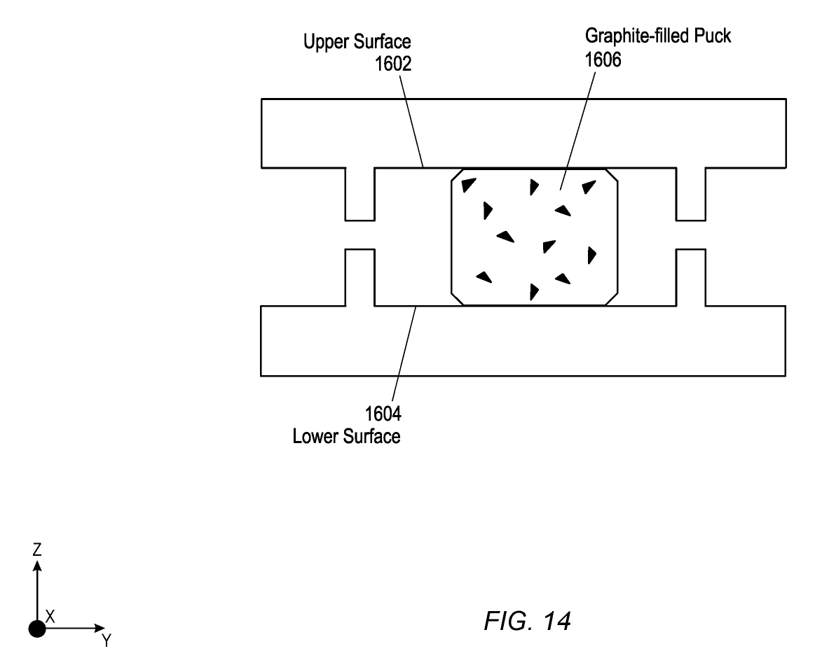

FIG. 14 illustrates components of yet other OIS carrier surfaces that may, for example, be used to provide OIS through lens movement in small form factor cameras, according to at least some embodiments. FIG. 14 shows a cross-sectional view of the OIS carrier surfaces. The features described and/or illustrated in FIG. 14 may include one or more same or similar features as the features described with respect to or illustrated in FIGS. 1, 2, 3, 4, 5, 6, 7, 8a, 8b, 8c, 9, 10, 11, 12, 13, 15, 16, 17, 18, and 19. The example X-Y-Z coordinate system shown in FIG. 14 may be used to discuss aspects of components and/or systems, and may apply to embodiments described throughout this disclosure.

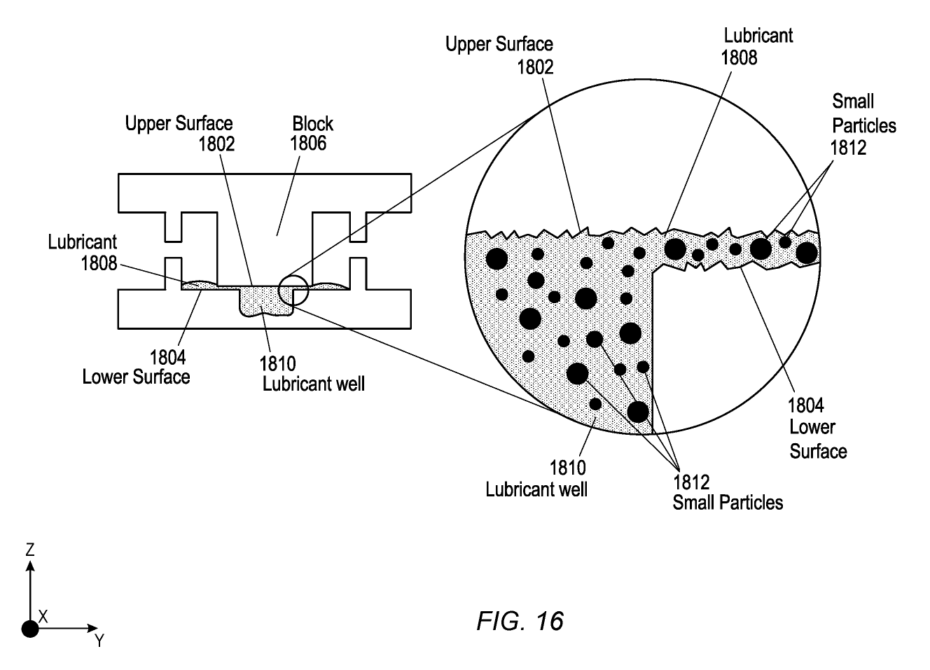

As described herein, the OIS carrier 304 may be vertically positioned (for example, along an optical axis 101) between the housing 110 and the base 318. The housing 110 may include a spacer 302 with one or more top surfaces 310c for engaging with (for example, make physical contact with) one or more respective upper surfaces 310a of the OIS carrier 304. In some aspects, the engaging may be for sliding movement between two flat surfaces or rolling movement between a flat surface and a rounded surface. Pre-load magnets positioned within the housing 110 and/or within the spacer 302 that are vertically aligned with OIS magnets 308 attached to the OIS carrier 304 may bias the OIS carrier 304 towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302. In some aspects, the top surface(s) 310c may include an upper surface 1602 (as shown in FIG. 14) and the upper surface(s) 310a may include a lower surface 1604 (as shown in FIG. 14). Also, as shown in FIG. 16, a puck 1606 may be positioned between the upper surface 1602 and the lower surface 1604. The puck 1606 may include graphite for low friction movement. Because the upper surface 1202 and the lower surface 1204 are flat surfaces and because the puck 1606 includes graphite for low friction movement, the puck 1606 may slide in an x-y plane. Thus, using the upper surface 1602, lower surface 1604, and the puck 1606 with the OIS carrier 304 and the housing 110, the OIS carrier 304 may be allowed to move in both the x direction and the y direction for OIS movement of the lens carrier 316.

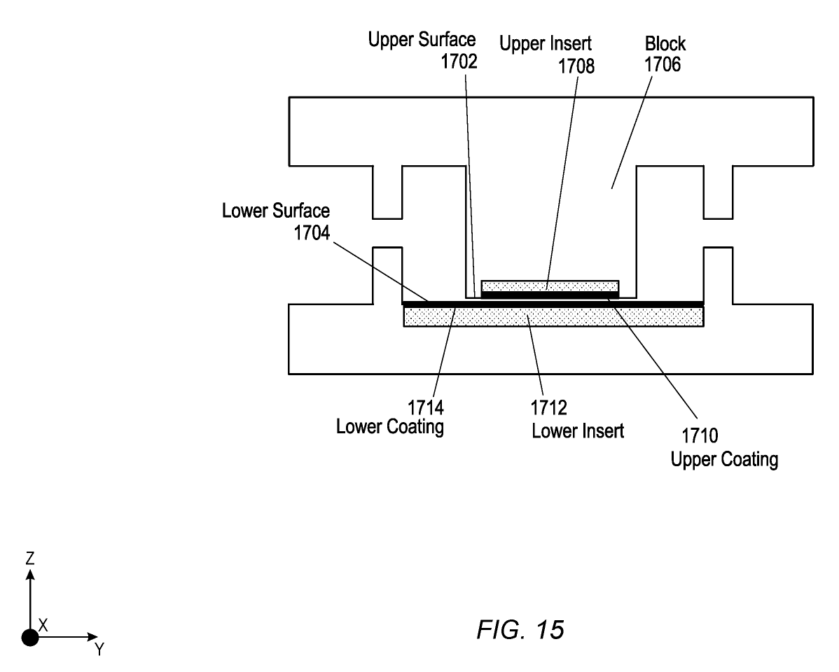

FIG. 15 illustrates components of yet other OIS carrier surfaces that may, for example, be used to provide OIS through lens movement in small form factor cameras, according to at least some embodiments. FIG. 15 shows a cross-sectional view of the OIS carrier surfaces. The features described and/or illustrated in FIG. 15 may include one or more same or similar features as the features described with respect to or illustrated in FIGS. 1, 2, 3, 4, 5, 6, 7, 8a, 8b, 8c, 9, 10, 11, 12, 13, 14, 16, 17, 18, and 19. The example X-Y-Z coordinate system shown in FIG. 15 may be used to discuss aspects of components and/or systems, and may apply to embodiments described throughout this disclosure.

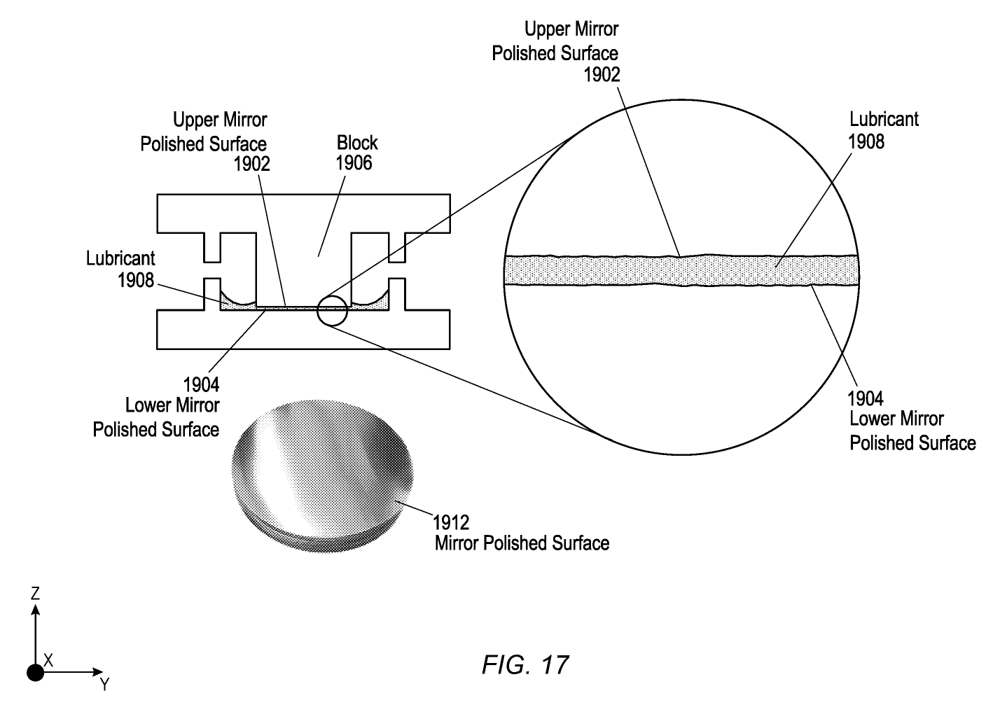

As described herein, the OIS carrier 304 may be vertically positioned (for example, along an optical axis 101) between the housing 110 and the base 318. The housing 110 may include a spacer 302 with one or more top surfaces 310c for engaging with (for example, make physical contact with) one or more respective upper surfaces 310a of the OIS carrier 304. In some aspects, the engaging may be for sliding movement between two flat surfaces or rolling movement between a flat surface and a rounded surface. Pre-load magnets positioned within the housing 110 and/or within the spacer 302 that are vertically aligned with OIS magnets 308 attached to the OIS carrier 304 may bias the OIS carrier 304 towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302. In some aspects, the top surface(s) 310c may include an upper surface 1702 formed by a block 1706 (as shown in FIG. 17) and the upper surface(s) 310a may include a lower surface 1704 (as shown in FIG. 17). Also, as shown in FIG. 15, the block 1706 may be positioned against the lower surface 1704 for sliding contact between the upper surface 1702 and the lower surface 1704. In addition, the upper surface 1702 may include an upper insert 1708 (for example, a metal insert) and the lower surface 1704 may include a lower insert 1712. The upper insert 1708 may include an upper coating 1710, such as a DLC (a diamond like PvD coating) or ceramic coating. Similarly, the lower insert 1712 may include a lower coating 1714, such as a DLC (a diamond like PvD coating) or ceramic coating. Because the upper surface 1702 on the block 1706 and the lower surface 1704 are flat surfaces and include the upper insert 1708, the lower insert 1712, the upper coating 1710, and the lower coating 1714, the block 1406 may slide in an x-y plane. The lower coating 1714 on the lower insert 1712 and the upper coating 1701 on the upper insert 1708 may create a low friction interaction between the upper surface 1702 and the lower surface 1704 for sliding movement. Thus, using the upper surface 1702 of the block 1706 and lower surface 1704 with the OIS carrier 304 and the housing 110, the OIS carrier 304 may be allowed to move in both the x direction and the y direction for OIS movement of the lens carrier 316.

FIG. 16 illustrates components of yet other OIS carrier surfaces that may, for example, be used to provide OIS through lens movement in small form factor cameras, according to at least some embodiments. FIG. 16 shows a cross-sectional view of the OIS carrier surfaces. The features described and/or illustrated in FIG. 16 may include one or more same or similar features as the features described with respect to or illustrated in FIGS. 1, 2, 3, 4, 5, 6, 7, 8a, 8b, 8c, 9, 10, 11, 12, 13, 14, 15, 17, 18, and 19. The example X-Y-Z coordinate system shown in FIG. 16 may be used to discuss aspects of components and/or systems, and may apply to embodiments described throughout this disclosure.

As described herein, the OIS carrier 304 may be vertically positioned (for example, along an optical axis 101) between the housing 110 and the base 318. The housing 110 may include a spacer 302 with one or more top surfaces 310c for engaging with (for example, make physical contact with) one or more respective upper surfaces 310a of the OIS carrier 304. In some aspects, the engaging may be for sliding movement between two flat surfaces or rolling movement between a flat surface and a rounded surface. Pre-load magnets positioned within the housing 110 and/or within the spacer 302 that are vertically aligned with OIS magnets 308 attached to the OIS carrier 304 may bias the OIS carrier 304 towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302. In some aspects, the top surface(s) 310c may include an upper surface 1802 formed by a block 1806 (as shown in FIG. 16) and the upper surface(s) 310a may include a lower surface 1804 (as shown in FIG. 16). Also, as shown in FIG. 16, the block 1806 may be positioned against the lower surface 1804 for sliding contact between the upper surface 1802 and the lower surface 1804. In addition, the lower surface 1804 may include lubricant 1808 positioned thereon and a lubricant well 1810 in the lower surface 1804 for supplying the lubricant 1808 onto the lower surface 1804. In some aspects, the lubricant 1808 may include small particular 1812 (for example, nanoparticles) for further reducing the friction through use of the lubricant 1808 between the upper surface 1802 and the lower surface 1804. Because the upper surface 1802 on the block 1806 and the lower surface 1804 are flat surfaces, the block 1806 may slide in an x-y plane. The lubricant 1808 with the small particles 1812 may create a low friction interaction between the upper surface 1802 and the lower surface 1804 for sliding movement. Thus, using the upper surface 1802 of the block 1806 and lower surface 1804 together with the lubricant 1808 and the lubricant well 1810 and with the OIS carrier 304 and the housing 110, the OIS carrier 304 may be allowed to move in both the x direction and the y direction for OIS movement of the lens carrier 316.

FIG. 17 illustrates components of yet other OIS carrier surfaces that may, for example, be used to provide OIS through lens movement in small form factor cameras, according to at least some embodiments. FIG. 17 shows a cross-sectional view of the OIS carrier surfaces. The features described and/or illustrated in FIG. 17 may include one or more same or similar features as the features described with respect to or illustrated in FIGS. 1, 2, 3, 4, 5, 6, 7, 8a, 8b, 8c, 9, 10, 11, 12, 13, 14, 15, 16, 18, and 19. The example X-Y-Z coordinate system shown in FIG. 17 may be used to discuss aspects of components and/or systems, and may apply to embodiments described throughout this disclosure.

As described herein, the OIS carrier 304 may be vertically positioned (for example, along an optical axis 101) between the housing 110 and the base 318. The housing 110 may include a spacer 302 with one or more top surfaces 310c for engaging with (for example, make physical contact with) one or more respective upper surfaces 310a of the OIS carrier 304. In some aspects, the engaging may be for sliding movement between two flat surfaces or rolling movement between a flat surface and a rounded surface. Pre-load magnets positioned within the housing 110 and/or within the spacer 302 that are vertically aligned with OIS magnets 308 attached to the OIS carrier 304 may bias the OIS carrier 304 towards the housing 110 and/or spacer 302 to facilitate maintained engagement between the upper surface(s) 310a of the OIS carrier 304 and respective top surface(s) 310c of the housing 110 and/or spacer 302 for movement (for example, sliding movement) of the OIS carrier 304 in the x and y directions relative to the housing 110 and/or the spacer 302. In some aspects, the top surface(s) 310c may include an upper surface 1902 formed by a block 1906 (as shown in FIG. 17) and the upper surface(s) 310a may include a lower surface 1904 (as shown in FIG. 17). Also, as shown in FIG. 17, the block 1906 may be positioned against the lower surface 1904 for sliding contact between the upper surface 1902 and the lower surface 1904. In addition, the lower surface 1904 may include lubricant 1908 positioned thereon. In addition, the upper surface 1902 and/or the lower surface 1904 may include mirror polished surface 1912 for reduced friction between the upper surface 1902 and the lower surface 1904. Because the upper surface 1902 on the block 1906 and the lower surface 1904 are flat surfaces, the block 1906 may slide in an x-y plane. The lubricant 1908 and the mirror polished surfaces 1912 on the upper surface 1902 and/or the lower surface 1904 may create a low friction interaction between the upper surface 1902 and the lower surface 1904 for sliding movement. Thus, using the upper surface 1902 of the block 1906 and lower surface 1904 together with the lubricant 1908 and the mirror polished surface(s) 1912 and with the OIS carrier 304 and the housing 110, the OIS carrier 304 may be allowed to move in both the x direction and the y direction for OIS movement of the lens carrier 316.

FIG. 18 illustrates a schematic representation of an example device 2000 that may include a camera (for example, as described herein with respect to FIGS. 1, 2, 3, 4, 5, 6, 7, 8a, 8b, 8c, 9, 10, 11, 12, 13, 14, 16, 17, and 19), in accordance with some embodiments. In some embodiments, the device 2000 may be a mobile device and/or a multifunction device. In various embodiments, the device 2000 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 2000 may include a display system 2002 (e.g., comprising a display and/or a touch-sensitive surface) and/or one or more cameras 2004. In some non-limiting embodiments, the display system 2002 and/or one or more front-facing cameras 2004a may be provided at a front side of the device 2000, e.g., as indicated in FIG. 18. Additionally, or alternatively, one or more rear-facing cameras 2004b may be provided at a rear side of the device 2000. In some embodiments comprising multiple cameras 2004, some or all of the cameras may be the same as, or similar to, each other. Additionally, or alternatively, some or all of the cameras may be different from each other. In various embodiments, the location(s) and/or arrangement(s) of the camera(s) 2004 may be different than those indicated in FIG. 18.

Among other things, the device 2000 may include memory 2006 (e.g., comprising an operating system 2008 and/or application(s)/program instructions 2010), one or more processors and/or controllers 2012 (e.g., comprising CPU(s), memory controller(s), display controller(s), and/or camera controller(s), etc.), and/or one or more sensors 2016 (e.g., orientation sensor(s), proximity sensor(s), and/or position sensor(s), etc.). In some embodiments, the device 2000 may communicate with one or more other devices and/or services, such as computing device(s) 2018, cloud service(s) 2020, etc., via one or more networks 2022. For example, the device 2000 may include a network interface (e.g., network interface 2010) that enables the device 2000 to transmit data to, and receive data from, the network(s) 2022. Additionally, or alternatively, the device 2000 may be capable of communicating with other devices via wireless communication using any of a variety of communications standards, protocols, and/or technologies.

FIG. 19 illustrates a schematic block diagram of an example computing device, referred to as computer system 2100, that may include or host embodiments of a camera (e.g., as described herein with respect to FIGS. 1, 2, 3, 4, 5, 6, 7, 8a, 8b, 8c, 9, 10, 11, 12, 13, 14, 16, 17, and 18). In addition, computer system 2100 may implement methods for controlling operations of the camera and/or for performing image processing images captured with the camera. In some embodiments, the device 2000 (described herein with reference to FIG. 18) may additionally, or alternatively, include some or all of the functional components of the computer system 2100 described herein.

The computer system 2100 may be configured to execute any or all of the embodiments described above. In different embodiments, computer system 2100 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 2100 includes one or more processors 2102 coupled to a system memory 2104 via an input/output (I/O) interface 2106. Computer system 2100 further includes one or more cameras 2108 coupled to the I/O interface 2106. Computer system 2100 further includes a network interface 2110 coupled to I/O interface 2106, and one or more input/output devices 2112, such as cursor control device 2114, keyboard 2116, and display(s) 2118. In some cases, it is contemplated that embodiments may be implemented using a single instance of computer system 2100, while in other embodiments multiple such systems, or multiple nodes making up computer system 2100, may be configured to host different portions or instances of embodiments. For example, in one embodiment some elements may be implemented via one or more nodes of computer system 2100 that are distinct from those nodes implementing other elements.

In various embodiments, computer system 2100 may be a uniprocessor system including one processor 2102, or a multiprocessor system including several processors 2102 (e.g., two, four, eight, or another suitable number). Processors 2102 may be any suitable processor capable of executing instructions. For example, in various embodiments processors 2102 may be general-purpose or embedded processors implementing any of a variety of instruction set architectures (ISAs), such as the x86, PowerPC, SPARC, or MIPS ISAs, or any other suitable ISA. In multiprocessor systems, each of processors 2102 may commonly, but not necessarily, implement the same ISA.

System memory 2104 may be configured to store program instructions 2120 accessible by processor 2102. In various embodiments, system memory 2104 may be implemented using any suitable memory technology, such as static random access memory (SRAM), synchronous dynamic RAM (SDRAM), nonvolatile/Flash-type memory, or any other type of memory. Additionally, existing camera control data 2122 of memory 2104 may include any of the information or data structures described above. In some embodiments, program instructions 2120 and/or data 2122 may be received, sent or stored upon different types of computer-accessible media or on similar media separate from system memory 2104 or computer system 2100. In various embodiments, some or all of the functionality described herein may be implemented via such a computer system 2100.

In one embodiment, I/O interface 2106 may be configured to coordinate I/O traffic between processor 2102, system memory 2104, and any peripheral devices in the device, including network interface 2110 or other peripheral interfaces, such as input/output devices 2112. In some embodiments, I/O interface 2106 may perform any necessary protocol, timing or other data transformations to convert data signals from one component (e.g., system memory 2104) into a format suitable for use by another component (e.g., processor 2102). In some embodiments, I/O interface 2106 may include support for devices attached through various types of peripheral buses, such as a variant of the Peripheral Component Interconnect (PCI) bus standard or the Universal Serial Bus (USB) standard, for example. In some embodiments, the function of I/O interface 2106 may be split into two or more separate components, such as a north bridge and a south bridge, for example. Also, in some embodiments some or all of the functionality of I/O interface 2106, such as an interface to system memory 2104, may be incorporated directly into processor 2102.

Network interface 2110 may be configured to allow data to be exchanged between computer system 2100 and other devices attached to a network 2124 (e.g., carrier or agent devices) or between nodes of computer system 2100. Network 2124 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 2110 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 2112 may, in some embodiments, include one or more display terminals, keyboards, keypads, touchpads, scanning devices, voice or optical recognition devices, or any other devices suitable for entering or accessing data by one or more computer systems 2100. Multiple input/output devices 2112 may be present in computer system 2100 or may be distributed on various nodes of computer system 2100. In some embodiments, similar input/output devices may be separate from computer system 2100 and may interact with one or more nodes of computer system 2100 through a wired or wireless connection, such as over network interface 2110.

Those skilled in the art will appreciate that computer system 2100 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 2100 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 2100 may be transmitted to computer system 2100 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A camera, comprising:
an image sensor;
an optical assembly having one or more lenses; and
an actuator assembly configured to move one of the image sensor or the optical assembly, wherein the actuator assembly comprises:
an optical image stabilization (OIS) carrier, wherein the OIS carrier is configured to move one of the image sensor or the optical assembly along two orthogonal axes for OIS,
a plurality of surfaces on the OIS carrier, wherein a surface portion of the plurality of surfaces is configured to make physical contact with another surface of another component to allow sliding or rolling movement between the surface portion of the plurality of surfaces and the other surface of the other component for allowing movement of the OIS carrier along the two orthogonal axes, and
an OIS actuator configured to move the OIS carrier along the two orthogonal axes.

2. The camera of claim 1, wherein the actuator assembly further comprises a rotation restriction mechanism configured to restrict rotational movement of the image sensor or the optical assembly about an axis orthogonal to the two orthogonal axes while permitting translational movement of one of the image sensor or the optical assembly along the two orthogonal axes.

3. The camera of claim 1, wherein the rotation restriction mechanism comprises at least one of a flexure arm, a coil and magnet pair, or a plate and magnet pair.

4. The camera of claim 1, wherein the surface portion of the plurality of surfaces and the other surface of the other component comprise flat surfaces.

5. The camera of claim 1, wherein the other component comprises a spacer on an interior of a shield can of the camera.

6. The camera of claim 1, wherein the surface portion of the plurality of surfaces comprises a flat surface, and wherein the other component comprises a ball bearing.

7. The camera of claim 1, wherein the surface portion of the plurality of surfaces comprises a flat surface, and wherein the other component comprises a cube or a cylinder.

8. The camera of claim 7, wherein the cube or the cylinder comprise graphite.

9. The camera of claim 1, wherein at least one of the surface portion of the plurality of surfaces or the other surface of the other component comprises a coating.

10. A device, comprising:
one or more processors;
memory storing program instructions executable by the one or more processors to control operation of a camera; and
the camera comprising:
an image sensor;
an optical assembly having one or more lenses; and
an actuator assembly configured to move one of the image sensor or the optical assembly, wherein the actuator assembly comprises:
an optical image stabilization (OIS) carrier, wherein the OIS carrier is configured to move one of the image sensor or the optical assembly along two orthogonal axes for OIS,
a plurality of surfaces on the OIS carrier, wherein a surface portion of the plurality of surfaces is configured to make physical contact with another surface of another component to allow sliding or rolling movement between the surface portion of the plurality of surfaces and the other surface of the other component for allowing movement of the OIS carrier along the two orthogonal axes, and
an OIS actuator configured to move the OIS carrier along the two orthogonal axes.

11. The device of claim 10, wherein the actuator assembly further comprises a rotation restriction mechanism configured to restrict rotational movement of the image sensor or the optical assembly about an axis orthogonal to the two orthogonal axes while permitting translational movement of one of the image sensor or the optical assembly along the two orthogonal axes.

12. The device of claim 10, wherein the rotation restriction mechanism comprises at least one of a flexure arm, a coil and magnet pair, or a plate and magnet pair.

13. The device of claim 10, wherein the actuator assembly further comprises an autofocus (AF) carrier retaining one of the image sensor or the optical assembly, wherein the AF carrier is configured to allow movement of the image sensor or the optical assembly, enabled by an AF actuator, along an axis orthogonal to the two orthogonal axes.

14. The device of claim 13, wherein the actuator assembly further comprises a rotation restriction mechanism configured to restrict rotational movement of the image sensor or the optical assembly about the axis orthogonal to the two orthogonal axes while permitting translational movement of the image sensor or the optical assembly along the two orthogonal axes and translational movement of the image sensor or the optical assembly along the axis orthogonal to the two orthogonal axes.

15. The device of claim 10, wherein the surface portion of the plurality of surfaces comprises a lubricant.

16. The device of claim 15, wherein the lubricant comprises a plurality of friction reducing particles.

17. The device of claim 15, wherein the surface portion of the plurality of surfaces comprises a reservoir configured to supply the lubricant to the surface portion.

18. The device of claim 10, wherein at least one of the surface portion of the plurality of surfaces or the other surface of the other component comprise a mirror polished surface.

19. An actuator assembly comprising:
an optical image stabilization (OIS) carrier, wherein the OIS carrier is configured to move one of an image sensor or an optical assembly along two orthogonal axes for OIS;
a plurality of surfaces on the OIS carrier, wherein a surface portion of the plurality of surfaces is configured to make physical contact with another surface of another component to allow sliding or rolling movement between the surface portion of the plurality of surfaces and the other surface of the other component for allowing movement of the OIS carrier along the two orthogonal axes; and
an OIS actuator configured to move the OIS carrier along the two orthogonal axes.

20. The actuator assembly of claim 19, further comprising a base positioned on an image side of the OIS carrier, wherein the OIS actuator comprises:
a first magnet positioned in a first arm of the OIS carrier;
a second magnet positioned in a second arm of the OIS carrier and adjacent the first arm;
a first coil positioned on the base and aligned with the first magnet in a direction parallel to an axis orthogonal to the two orthogonal axes; and
a second coil positioned on the base and aligned with the second magnet in the direction parallel to the axis orthogonal to the two orthogonal axes.
